(19) United States
(12) Patent Application Publication
(10) Pub. No.: US 2008/0222004 A1
(43) Pub. Date: Sep. 11, 2008

(54) Order Entry Graphical User Interface

(75) Inventors: Rick Pollock, Oak Park, IL (US); John Jasper, Arlington Heights, IL (US); James Van Vleet, Fargo, ND (US); Csaba Harsvolgyi, (US); Peter Deli, (US); Tamas Malik, (US)

Correspondence Address: BRINKS HOFER GILSON & LIONE, P.O. BOX 10395, CHICAGO, IL, 60610, US

(73) Assignee: Verety, LLC

(21) Appl. No.: 11/856,398

(22) Filed: Sep. 17, 2007

Related U.S. Application Data
(60) Provisional application No. 60/893,239, filed on Mar. 6, 2007.

(51) Int. Cl. G06Q 30/00

(52) U.S. Cl. 705/26

(57) ABSTRACT

This patent discloses various systems and embodiments for implementing, establishing and operating a remote order interface system and method. One exemplary embodiment of a remote order entry system includes a communications network, a first order entry workstation communicatively coupled to the communications network and configured to store a baseline commodity listing. The system further includes a second order entry workstation communicatively coupled to the first order entry workstation via the communication workstation and configured to communicate a remote commodity listing to the first order entry workstation, and a graphical user interface executable on the first order entry workstation and configured to display the baseline commodity listing in a first arrangement and the communicated remote commodity listing as a function of the first arrangement.

### PRIORITY CLAIM

This patent claims the priority benefit provided under 35 U.S.C. § 119(e) to U.S. provisional patent application Ser. No. 60/893,239, filed on Mar. 6, 2007, the content of this provisional patent application is incorporated herein by reference for all purposes.

### CROSS REFERENCE TO RELATED APPLICATIONS

This patent relates to commonly-assigned U.S. patent application Ser. No. 11/411,705 (12764-00004), filed on Apr. 26, 2006, titled “Order Processing Apparatus and Method;” and U.S. patent application Ser. No. 11/528,819 (12764-00008), filed on Sep. 26, 2006, titled “Order Processing Apparatus and Method;” and U.S. patent application Ser. No. 11/512,899 (12764-00005), filed on Aug. 30, 2006, titled “Order Distributor,” the contents of these applications are incorporated herein by reference for all purposes.

### BACKGROUND

Retail transactions typically include several component-transactions, such as: (i) receiving one or more orders for goods and/or services, each particular order referred to as an order component, (ii) receiving payment for those goods and/or services, (iii) delivering the ordered goods and/or services or otherwise fulfilling the order, or a combination thereof. The location at which one or more of these component-transactions occurs is known as the point of sale (“POS”). In many retail environments the point of sale also serves as a point of order entry, the point of payment and/or the point of order fulfillment. For example, retail stores often integrate order entry points, i.e. POS terminals, such as integrated order input/cash registers, with a restaurant POS system (“RPOS” system), e.g. a system, typically including a network and server, which interconnects the POS terminals with displays or terminals in the production area to convey and track orders, etc. under the management of appropriate software. Orders are typically entered into the POS system via the POS terminal, such as a cash register, inside the retail store. In other implementations, order entry, order payment and order fulfillment may occur at multiple different points/locations, as will be described below.

Exemplary retail stores include restaurants, such as a quick service restaurant or a fast food restaurant, where a customer may, for example, verbally convey orders to a cashier located at a counter inside the restaurant. Upon receiving the order, the cashier enters the order into the RPOS system via the POS terminal. The POS terminal, which may be an integrated order input/cash register that calculates the total price, transmits the order to the kitchen staff. The POS terminal (often referred to as a “point-of-sale register”, or “POS register”) often includes a POS terminal user interface having custom hardware and/or software and, in a many implementations, includes virtual or physical buttons or keys representing each of the various items offered for sale. This simplified order entry interface streamlines and accelerates the order entry process as well as minimizes errors therein. In this manner, the cashier/counter person, upon hearing a customer order a specific item, need only push the button or key corresponding to that item, thereby entering the specific item ordered in to the RPOS system and recording the corresponding price for totaling purposes. The customer then typically pays for the food and in response; the cashier/counter person delivers the food to the customer.

Rather than place an order with a counter clerk at a POS terminal from within a restaurant, a customer may place their order from a remote POS location. For example, a remote POS location may be a drive-through order placement system; a computer based ordering kiosk or a telephone coupled or otherwise in communication, with an order taker/cashier at a POS terminal within the restaurant via a dedicated connection. A drive-through POS location may include a speaker post and feature signage showing the restaurant menu, i.e. menu board. The cashier/order taker within the restaurant, upon hearing the order, may then enter the customer's order into the RPOS system via their POS terminal. For example, a customer may drive their car to a location proximate to the speaker post and menu board. The menu board lists the available items for order and their prices. An audio system connected to the speaker post allows two-way communication between the customer and the order taker/cashier located inside the building. Further, the audio system also may allow other staff in the restaurant to monitor the communication between the customer and the order taker/cashier. In response to the customer's verbal menu selections, the cashier enters the order into the POS terminal. The cashier verifies the customer's order and typically tells the customer the total amount owed. This arrangement provides the customer with the convenience of placing and picking up orders without leaving their car, and allows the restaurant to serve customers using two avenues: inside and drive-through. After placing their order and receiving their total, the customer drives to a window in the building where he may speak with the attendant face to face, pay the amount owed and subsequently receive the ordered food or merchandise.

While conventional drive-through order placement systems offer the advantages of customer convenience and increased product delivery channels, there are several disadvantages to such systems. For example, the lack of adequately trained cashier/counter agents often leads to errors in taking orders. Such errors lead to customer irritation and annoyance and may further lead to, or compound with, other errors resulting in unacceptable delays in servicing customers and, potentially, lost customers, lost goodwill and lost revenue. Unfortunately, the labor pool for such establishments is shrinking at the same time that demand is increasing. Identifying, training, retaining and scheduling courteous and capable personnel is becoming one of the most critical concerns in the management of restaurants. This is particularly true in quick service/fast food restaurants. Such establishments emphasize the delivery of food in a consistent, timely and relatively inexpensive manner, while delivering consistently high quality products. Effective and capable employees are a prerequisite for achieving each of these goals.

It would be desirable to provide a system and method for addressing the limitations described above while streamlining the order processing system. Furthermore, it would be desirable to provide an order entry interface that can quickly, easily and efficiently interact and cooperate with a remote POS location or device. The order entry interface could, among other things, enhance the customer's satisfaction while allowing the retail location, e.g., the fast food restaurant, to maximize employee efficiency

### BRIEF DESCRIPTION OF THE FIGURES

FIG. 1 is a block diagram of one embodiment of an order processing system;

FIG. 2 is a block diagram of another embodiment of an order processing system;

FIG. 3 is a flow chart of the operations of one embodiment of the remote order processing system;

FIG. 4 illustrates one embodiments of a graphical user interface implemented in accordance with the disclosure presented herein;

FIGS. 4A and 4B illustrate possible embodiments of menu icons that may be utilized in cooperation with the graphical user interface shown in FIG. 4;

FIG. 5 is a flow chart of an overall menu normalization operation of one embodiment of the remote order processing system; and

FIG. 6 is a flow chart of a database update or synchronization operation of one embodiment of the remote order processing system.

Additional features and advantages of the present invention are described in, and will be apparent from, the following Detailed Description, the disclosed embodiment and the figures.

### DETAILED DESCRIPTION

### I. System Layout and Network

The remote order processing system 100 described herein includes hardware and software embodiments configured and provided to facilitate order taking and remote order taking for a restaurant or other sales and service supplier. The following section(s) describes: (i) the hardware associated with the remote order processing system 100, (ii) embodiments of potential communications layouts for such as system, (iii) system updating and alternate communications schema and (iv) alternate system architecture and layouts for use during normal operations and failure conditions.

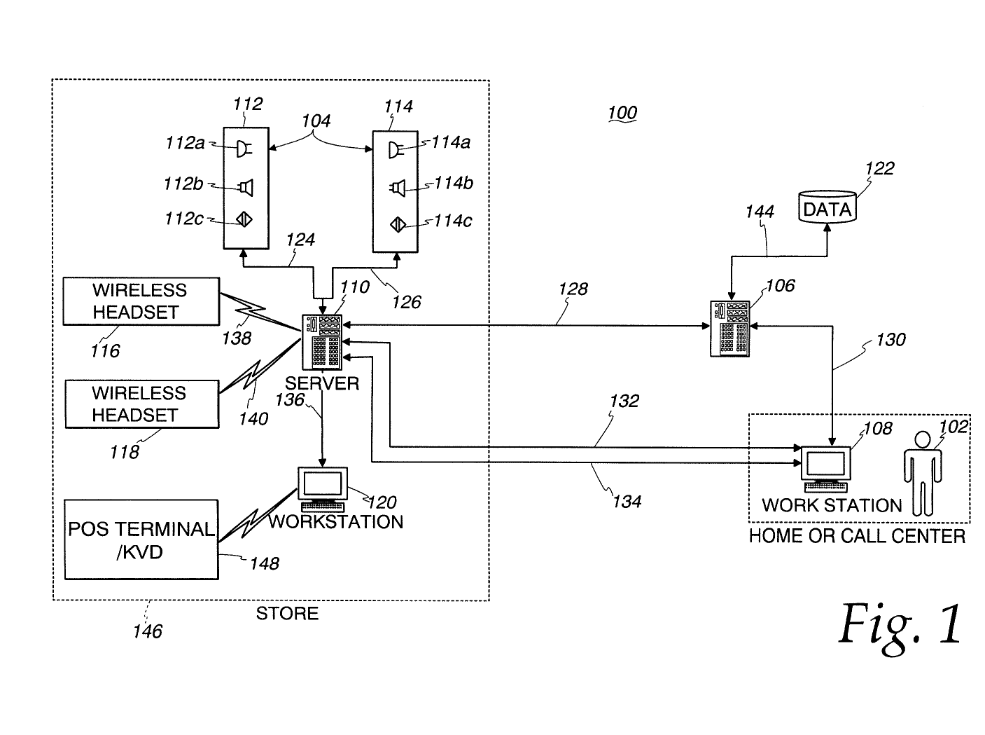

FIG. 1 illustrates a block diagram of a remote order processing system 100 according to one embodiment. The remote order processing system 100 facilitates order intake using remote order taking agents 102 which are located remotely from the point of sale, as will be described. The order processing system 100 is designed to accommodate a customer who places an order at a remote point of sale (“POS”) location 104 associated with, for example, a wholesale or retail store or a service location such as a restaurant and/or a market. The order may include one or more order components, i.e. one or more items, goods or services that the user wishes to purchase, collectively or separately, during the present interaction/transaction. POS locations 104 may be, for example, inside the store (not shown), such as a counter, a kiosk or outside the store, such as along a drive-through lane which allows a customer to place, pay and receive fulfillment of an order without leaving their automobile. The POS location 104 may be a speaker post, a table top device and/or a standard telephone where a customer at least places an order, the order consisting of one or more order components, e.g. for one or more goods or services provided by the store or restaurant. Depending upon the implementation, the POS location 104 may further include the point of payment, order fulfillment or some combination thereof. As described, the POS location 104 may feature a POS terminal (not shown) at which a counter clerk enters the order, in the case of a POS location 104 inside the store, or an order communication system in communication with someone who enters the order, as will be described below, in the case of a remote POS location 104, such as a drive-through.

In one embodiment, an order taking session is initiated between a customer, located at a remote POS location 104, and a remote order taking agent 102, located in a call center or elsewhere such as in their home, via the detection of the customer waiting to place an order at the remote POS location 104. As will be described, the remote order taking agent 102 may service multiple different retail establishments and locations, e.g. multiple different restaurants. A signal indicative of the customer detection is communicated via a connectionless protocol to an order distributor 106 which, in turn, identifies and selects a remote order taking agent 102 to handle the order. The actual communication session may then be subsequently initiated, in response to the agent 102 being selected by the order distributor 106, either by the selected remote order taking agent 102 with the remote POS location 104 or by the remote POS location 104 with the selected remote order taking agent 102. The selected remote order taking agent 102 may be, in turn, prompted with a particular normalized menu representative of one of a plurality of possible commodity listings, menus and/or menu items offered by the remote POS location 104 prior to taking the order of the customer as will be described. As used herein, commodities, commodity information and/or commodity listings describe any and all products, menu items, services and business rules related thereto that may be offered by a retailer or retail location that utilizes the disclosed remote order processing system 100. A commodity listing, such as a menu of products and/or services offered by a retail establishment, may be characterized by both the content/offerings of the establishment, i.e. the specific products/services, applicable options, modifications, promotions or other business rules, or groupings/packages thereof, offered for sale, as well as the presentation of that content to both to the customer and employees, i.e. the order and arrangement of the offerings including their visual placement, visual representations, symbology, etc. The menus of two or more restaurants may offer the same products/services but present them in different ways, such as by naming or numbering the products/services using different schemes. A baseline commodity listing refers to a commodity listing, or portion thereof, which two or more establishments have in common or which generally remains constant over a given period of time, such as day to day or month to month, and may be a subset of the overall commodity listing of one or more restaurants. A normalized commodity listing refers to a commodity listing having a normalized presentation which may or may not be the same as the original presentation of the underlying commodity listing.

In an alternate embodiment, an order distributor 106 (a.k.a. Task Distribution Engine), in response to being notified of a customer waiting to place an order at a particular remote POS location 104, selects a remote order taking agent 102 to handle the order and sends at least a notification thereto, the selection being based on, in one embodiment, a criteria other than just the availability of the agent 102 to take the order. The additional selection criteria may include, for example, agent/customer compatibility, store/menu familiarity, demand, current store/queue status, etc.

In yet another alternative embodiment, a remote order processing system 100 provides the capability of electronically communicating a customer articulated/vocalized order, received from a customer at the remote POS location 104, to the remote order taking agent 102 located remote from the remote POS location 104 wherein the system 100 is further capable of automatically or manually processing the received vocalizations to enhance their intelligibility. The vocalizations can be degraded for a number of reasons, for example, poor articulation by the customer, faulty or improperly maintained equipment and/or signal interference along the communications line or circuit.

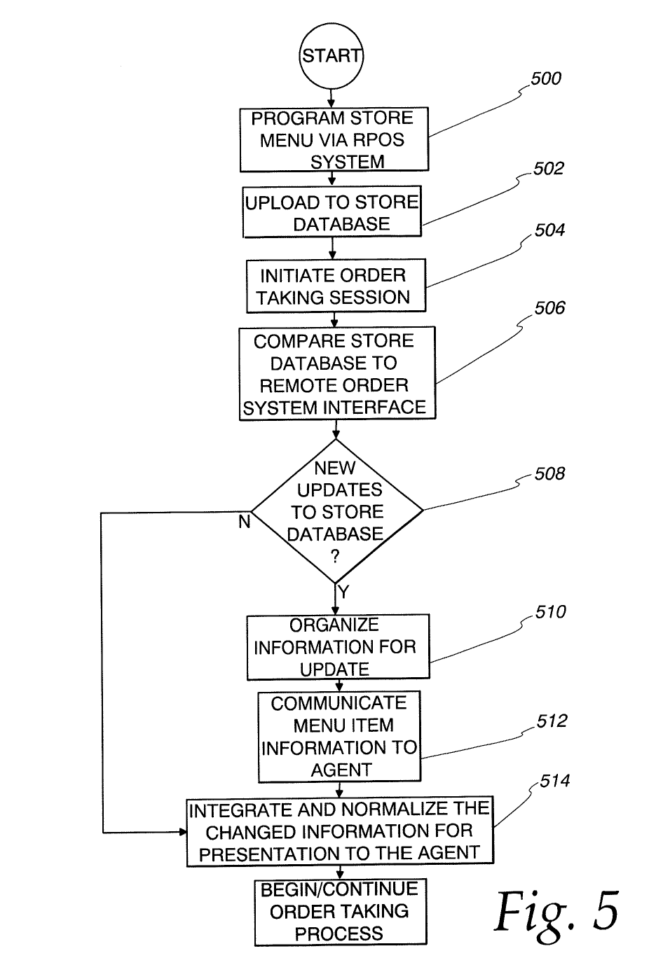

In yet another alternative embodiment, the remote order system 100 is adapted for taking orders from a plurality of remote stores, each characterized by a particular commodity list, such as a particular menu offering and/or arrangement of products and/or services or packages/groupings thereof, particular promotions, or combination thereof. The remote order system 100 in this exemplary embodiment may include a plurality of remote order taking agents 102, each associated with a remote order taking terminal 108, wherein each remote order taking terminal 108 is capable of taking an order from each of the plurality of remote stores and further capable of dynamically prompting the remote order taking agent 102 with an interface comprising the menu, promotion, programmable or customizable messaging system or dialog configured to enhance service quality, or a combination thereof associated with the store from which the order is being taken. The remote order taking terminal 108 will typically include a PENTIUM® or OPTERON® class processor provided by INTEL® or ADVANCED MICRO DEVICES® (AMD®), respectively, a hard drive and random access memory configured to store and execute the order processing software. In one embodiment, the PENTIUM® processor may be a P4 processors configured to operated 2 GHz or more. The remote order taking terminal 108 can also include a seventeen inch (17″) liquid crystal display (LCD) such as a model E177FP distributed by DELL™. The exemplary LCD display can, in turn, cooperate with the processor and a graphics card to provide 1152×864 resolution. The remote order taking terminal 108 can be configured to dynamically present a unified or standardized prompt/interface (illustrated in FIG. 5 and described in detail in Section II-C) to the remote order taking agent 102 representative of the commodity listing, promotion or a combination thereof associated with the retail location from which the order is being taken, the presentation being similar for each menu, promotion or combination thereof for each store.

In yet another alternative embodiment, the remote order processing system 100 for taking orders from a plurality of remote stores includes a plurality of remote order taking agents 102, each associated with a remote order taking terminal 108 capable of being coupled with an audio and/or visual interface located at each of the plurality of remote POS location 104, the audio and/or visual interface being capable of automatically prompting a customer, in response to the customer's arrival at the remote POS location 104, with a greeting, the status of the connection between the customer and the remote order taking agent 102, available promotions for the associated store, or a combination thereof.

As will be described, the remote order processing system 100 detects the presence of a customer at the remote POS location 104, such as a drive-through POS location 104, and via a connectionless medium, (i) initiates an order taking session, (ii) selects the remotely located or remote order taking agent 102 to take the customer's order, (iii) establishes communications, whether over the connectionless medium or otherwise, between the selected remote order taking agent 102 and the store 146 and between the selected remote order taking agent 102 and the customer, and (iv) processes the order as it is received by the agent 102 from the customer to communicate the order to the store 146 for fulfillment. Mechanisms are further provided to enhance the customer's experience, such as via optimized agent selection and/or intuitive order confirmation, detect and handle system failures, such as via back-up order in-take systems, and overall improve workflow efficiency both within the retail location and among multiple retail locations. In an alternative embodiment, the remote order processing system 100 is implemented so as to more easily integrate with a restaurant's existing technology infrastructure.

In the present embodiment, the remote order processing system 100 includes a remote order system interface 110, also referred to herein as the system interface 110, order processing device, remote order center (“ROC”) interface or “ROClink” interface, and one or more speaker posts 112, 114 coupled with the system interface 110. Herein, the phrases “communicatively coupled,” “in communication with,” and “coupled with” are defined to mean directly connected to or indirectly connected through one or more intermediate components. Such intermediate components may include both hardware and software based components. The system interface 110 manages order intake and processing. The speaker posts 112, 114, described in more detail below, are used to communicate with customers and, in the present embodiment, are located proximate to the respective remote/drive-through POS locations 104. The system interface 110 may further be coupled with one or more wired or wireless headsets 116, 118 as an alternative mode for receiving an order by an employee, agent within the store 146. The system interface 110 is further coupled with the store's RPOS system 120, or a workstation component thereof, located within the store for processing or otherwise entering the order into the store's RPOS system 120 to facilitate the fulfillment of the order. The RPOS system 120 may include a POS server (not shown), one or more POS terminals or workstations (not shown), such as cash registers and/or order input devices, drive-thru expos, grill slip printers and one or more kitchen video systems (KVSs) (not shown) configured for use by the crews or teams charged with the order preparation and/or fulfillment. The RPOS system 120 may be implemented as a centralized architecture, e.g. using dumb-terminals coupled with a central computer, or a distributed architecture, e.g. intelligent terminals coupled together as peer devices. Alternatively, the RPOS system 120 can be implemented as a client server architecture, i.e. a hybrid of the centralized and distributed architectures, where the POS terminals and KVDs are intelligent devices which execute client software that interacts via the network with the POS server to implement the order processing/fulfillment applications.

The system interface 110 is further coupled with the order distributor 106, which may be remote from the store. The order distributor 106 can be coupled with a group of remote order taking agents 102, each located at an associated remote agent terminal 108. In one embodiment, the order distributor 106 selects one remote order taking agent 102/terminal 108 from the group for the purpose of taking the customer's order. The selected agent 102 then takes the customer's order using an audio connection established between the associated remote agent terminal 108 and speaker post 112, 114, via the system interface 110, as will be described in more detail below. The order distributor 106 may further be coupled with a store database 122, also referred to as a “ROCLink store database”, which contains and organizes store information for the plurality of stores utilizing the remote order processing system 100.

The speaker posts 112, 114 are in communication with and provide a simple interface between the system 100 and the customer, such as a customer present at one of the remote POS locations 104, for at least the purpose of taking the customer's order. For example, one or more speaker posts 112, 114 may be located at the store and may each be a separate free-standing device physically separate from the store and located along the store's drive-through lanes. Alternatively, one or more speaker posts 112, 114 may be located inside the store. In one embodiment, the speaker posts 112, 114 may be stand alone devices including audio speakers 112a and microphones 112b and a suitable controller to facilitate, e.g. receive and communicate/relay, audible communications between the customer and the remote order taking agent 102 at the remote agent terminal 108, either directly, i.e. peer-to-peer, via the system interface 110, or indirectly via the order distributor 106. It will be appreciated that the logical and physical connections between these devices may differ. For example, the speaker posts 112, 114 may be network addressable devices in logical communication with the system interface 110 while physically connected to an entirely different portion of the system 100. Alternatively, as described above, the speaker posts 112, 114 may directly provide audio input to the system interface 110. The system interface 100, in turn, manages and controls the audio connection between the customer and the system 100. Regardless of the implementation, the microphone 112b and the speaker 112a may be combined, e.g. the same device may serve as both the microphone and speaker in a half-duplex implementation or, alternatively, simply mounted within the same housing.

In one embodiment, the speaker posts 112, 114 may include a telephone, intercom or similar device, over which the customer communicates audibly. The speaker posts 112, 114 may also include a display that provides the customer with prompts, messages, indicators and/or cues which enhance the customer's interactive experience and satisfy the customer's need for feedback, such as a visual indication of the order components as they are entered and, possibly, a running total of the price of their order and/or other information, e.g. advertisements, etc. Other visual indications which may be provided to the customer include an indication that the presence of the customer has been detected and that an agent is forthcoming to take their order, an indication that an appropriate agent is in the process of being selected based on, for example, the customer's dialect, an indication that the customer is presently connected with an agent, such as to prevent “dead air,” an indication that the customer should speak their next order component that they wish to order or otherwise indicate that they are finished ordering, an indication that there is a problem and that the customer should go to the service window or otherwise that assistance is forthcoming, or combinations thereof. Moreover, the customer may, via the speaker posts 112, 114, initiate the call, select or identify the language in which the call or display will be conducted and/or presented, or communicate via a voice or command recognition system embedded or in communication with the speaker posts 112, 114. The display may be located on the speaker posts 112, 114 or may be separate but proximate thereto.

The speaker posts 112, 114 may further include signage such as a menu board or other display of the commodities, items and/or order components available for purchase, such as the restaurant menu. In one embodiment, a store may provide multiple speaker posts 112, 114. For example, with two or more drive-through lanes, each lane may have a speaker post 112, 114. In an alternate embodiment, the speaker posts 112, 114 may be remote terminals for receiving an order from a customer via unattended customer input, taking the customer's order, for example, via a keypad, touch screen and/or voice recognition.

In addition, the remote POS location 104, such as the speaker post 112, 114, includes a presence detector 112c, 114c coupled with the speaker post 112, 114, which detects the presence of a customer at the associated remote POS location 104. Upon detection of a customer's presence, the presence detector 112c, 114c generates an alert signal 124, 126 indicating the presence of the customer, i.e. a customer arrival alert. The presence detector 112c, 114c may further cause the display of a message such as, for example, a store specific promotional message, or other indicator to the customer to acknowledge that the customer's presence has been detected, e.g. “your order taker will be right with you” or “please wait” or other suitable message or indicator to enhance the customer's interactive experience, as was described above.

In one embodiment, the signal 124, 126 is communicated to the system interface 110, as discussed below, to ultimately cause selection of an order taking agent 102 and the establishment of at least a data connection, e.g. a P2P connection, between the system interface 110 and the remote agent terminal 108. The data connection allows the remote agent terminal 108 to communicate with the RPOS system 120 within the store, via the system interface 110, what items the customer has ordered while, or after, the order had been placed. Further, the data connection can be further utilized to establish an audio connection, e.g. using Voice Over Internet Protocol (“VoIP”), between the speaker post 112, 114 and the remote agent terminal 108. Alternatively, the audio connection may be established via an alternative connection or medium, such via the public switched telephone network, a private branch exchange, a separate VoIP session or other medium of communications, or combinations thereof. In one embodiment for use at a drive-through restaurant, the presence detector 112c, 114c may be of a type that detects the presence of the customer's automobile, such as via an inductive, magnetic, pressure, optical or human based mechanism. It will be appreciated that the manner of detecting the presence of the customer is implementation dependent and may include manual detection means such as the pressing of a call-button or detection of a vocal annunciation by the customer, e.g. a voice activated presence detector 112c, 114c.

The system interface 110, in at least one aspect, acts as an intermediary that responds to the alert signal 124, 126 that indicates detection of a customer at, for example, the speaker post 112, 114. The system interface 110, in turn, facilitates establishment of a connection between the remote order taking agent 102, at their associated remote agent terminal 108, and the customer at the speaker post 112, 114 or within the store 146. The system interface 110 may be implemented in hardware, software or a combination thereof, and may include general purpose hardware, such as a personal computer or other computing device. In one embodiment, the system interface 110 may be implemented in software, so that it may be easily upgraded, modified and/or maintained. The system interface 110 may be a component of a POS terminal (not shown), located at the store, such as a standalone server or part of the POS server (not shown) of the RPOS system 120, located outside the store, or may be combined with one or more of the speaker posts 112, 114. In one embodiment, the system interface 110 may serve a plurality of stores. For example, the system interface 110 may be coupled with a set of restaurants located within a single city, such as a set of restaurants which may share a drive-thru POS location 104. In one embodiment, as described above, the system interface 110 receives the customer presence signal 124, 126 generated by the customer presence detector 112c, 114c based on the arrival and detection of a customer at one of the remote POS locations 104, such as the speaker posts 112, 114, e.g. based on an indication that a customer has pulled up to one of the speaker posts 112, 114, in their car. This alert signal 124, 126 may indicate not only that a customer is present but at which remote POS location 104 the customer is located in embodiments having multiple speaker posts 112, 114.

### A. System Communications

The system interface 110, upon receiving the alert signal 124, 126 generated by the presence detector 112c, 114c transmits a customer arrival alert 128, also referred to herein as an order request, to the order distributor 106. The customer arrival alert 128 may be a signal and/or one or more messages, as will be described. In an alternative embodiment, the customer presence detector 112c may transmit the customer arrival alert 128 directly to the order distributor 106. In one embodiment, the customer arrival alert 128 is a data message, transmitted via a connectionless protocol, which indicates that a customer has arrived at the POS location 104 and is waiting to place an order. A connectionless protocol is one in which a sender transmits a message by addressing the message to the recipient and placing it on a network to be delivered based on that address, but not otherwise establishing a connection with that recipient prior to transmitting. The exchange of communications in this way, for a given purpose, is typically referred to as a “session,” a “virtual connection” or “virtual call.” Once the purpose has ended, the session is ended. For example, a session may be established for taking a particular order and once the order is complete, the session is ended. The customer arrival alert 128 may further include identification information identifying the store, the store location, the particular remote POS location 104 and/or the customer, as discussed below. The customer arrival alert 128 may implicitly specify identification information such as where the alert 128 is conveyed over a dedicated identifiable connection used only by a particular store or remote POS location, etc. Alternatively, the customer arrival alert 128 may be one or more messages which explicitly specify/contain the identification information, or this information may be specified via a combination of implicit and explicit specifications.

In an alternate embodiment, the customer arrival alert 128 may specify store information, also referred to herein as destination information, which may be used to assist the order distributor 106 in selecting an appropriate remote order taking agent 102 or set thereof, assist the selected remote order taking agent 102 in taking the order, or a combination thereof. Store information may include information about the particular store, information about the remote POS location 104 originating the customer arrival alert 128, information about the other POS locations 104 at the particular store and/or information for the customer, such as the store's operating hours, the store's menu, as will be described in more detail below, the current backlog of orders, the current queue depth at the particular remote POS location or all/other POS locations, the present inventory level of particular products, the status of the machines used by the store to produce particular products, any current promotions offered by the store, the language spoken by the customer, or combinations thereof. As will be described, store information, or a subset thereof, may be selectively communicated only when the information has changed subsequent to a prior communication of that store information.

It will be appreciated that the media over which the interactions or communications such as, for example, the alert signals 124, 126, the customer arrival alert 128, the signals or communications 130, 132, 134 between the order distributor 106, the remote agent terminal 108 and the system interface 110, and all other connections described herein, may include wired or wireless connections, including wired networks, wireless networks, or combinations thereof. Further, wherein the connections/interactions are implemented over one or more networks, these networks may include publicly accessible networks, such as the Internet, a private network, such as an intranet or virtual private network (VPN), or combinations thereof, and may utilize a variety of networking protocols now available or later developed including, but not limited to, TCP/IP based networking protocols.

As will be described, the system interface 110 is selectively coupled with a selected remote agent terminal 108, to facilitate a data connection between a remote agent terminal 108 and the system interface 110, in response to receiving a session request 132 from the selected remote agent terminal 108, the session request 132 having been generated in response to the customer arrival alert 128 being received by the order distributor 106 and the communication thereof to the selected remote agent terminal 108. This data connection is referred to as a session and is maintained for the duration of the order taking process as described herein and may be closed or ended when the order taking process is complete. The session is established for the transfer of indicators of one or more of the order components from the remote agent terminal 108 to the system interface 110 as the remote order taking agent 102 receives the order components from the customer, such as from the customer over an audio connection, and enters those order components into the remote agent terminal 108, described in more detail below. The system interface 110 may be further coupled with the RPOS system 120, as described below, to communicate order data, i.e. the received order component indicators, to the RPOS system 120 to ensure that the order is fulfilled at the store by transmitting or displaying the order information as discussed below. The system interface 110 may also facilitate an audio connection between the customer at the POS location 104, e.g. the speaker post 112, 114, and the remote order taking agent 102 at the remote agent terminal 108, allowing the customer and the remote order taking agent 102 to audibly communicate. It will be appreciated that during a P2P configuration, the audio communication need not flow through the order distributor 106. In one embodiment, this audio connection may be implemented within the existing session for the data connection, such as by using Session Initiation Protocol (“SIP”)/VoIP or other protocol for implementing an audio connection over a connectionless network. Quality of Service (QoS) protocols may be further implemented to ensure adequate and intelligible voice communications. Alternatively, the audio connection may be implemented outside of the system interface 110 via a separate medium of communication, including the PSTN.

As described above, in response to the customer arrival alert 128, the order distributor 106, alone or in concert with the system interface 110, selects a remote order taking agent 102 at a remote agent terminal 108, from a set of remote order taking agents 102, which will then initiate communications with the customer via the system interface 110. However, in some installations of the disclosed system 100, it may be necessary to integrate the disclosed system 100 with an existing technology infrastructure, such as an existing communications network. Alternatively, the store 146 may have particular concerns regarding the security of the communications between the customer and the remote order taking agent 102. These concerns may be addressed by having the system interface 110 instead initiate the communications with the selected remote order taking agent 102.

In yet another alternate embodiment, the system interface 110, rather than the remote order taking agent 102, initiates communications between the customer and the remote order taking agent 102 in response to the customer arrival alert 128. This permits the system interface 110 to exert more control over the manner in which such communications are implemented, i.e. security protocols, desired communication path, etc. Further, where the store 146 has a communications network with a firewall device which may block unsolicited communications, i.e. would block remote order taking agent 102 initiated communications, the initiation of communications from within the store, i.e. behind the firewall, would create an authorized or solicited relationship with the remote agent terminal 108 that allows for unimpeded communications through the firewall.

In this alternative embodiment, the system interface 110 receives the session request 142 from the order distributor 106 to set up a session with the remote agent terminal 108 that has been identified by the order distributor 106 in response to the customer arrival alert 128 which the system interface 110 previously transmitted. The session request 142 may include information related to the selected remote agent terminal 108 that can be utilized to facilitate the establishment of at least a data connection between the system interface 110 and the remote agent terminal 108. In one embodiment, the session request 142 may identify a set of remote agent terminals 108 for the system interface 110 to choose from, the set being selected as described herein. Further, via the same mechanism, an audio connection may also be established between the customer located at the speaker post 112, 114 and the agent at the remote agent terminal 108 via, for example, a VoIP connection. Alternatively, the audio connection may be established via an alternative mechanism, such via the public switched telephone network, a private branch exchange or other medium of communications, or combinations thereof.

It will be appreciated that the functions of the order distributor 106 may be integrated with the system interface 110 allowing the system interface 110 to select an appropriate remote order taking agent 102 in response to receiving a customer arrival alert 128, without first having to communicate with the order distributor 106. In this embodiment, there may be no order distributor 106 or, alternatively, the order distributor 106 may manage and monitor the remote order taking agents 102 and supply such information to the system interface 110 asynchronous to the order taking process to update the system interface 110 to the status of the various remote order taking agents 102, thereby allowing the system interface 110 to select an appropriate remote order taking agent 102.

In this system interface 110 initiated embodiment, the system interface 110 may then provide store information to the remote agent terminal 108 rather than this information coming from the order distributor 106, as described below. Alternatively, the order distributor 106 may also be in communication with the selected remote agent terminal 108 to, for example, provide store information or to alert the selected remote order taking agent 102 or remote agent terminal 108 to expect a session to be initiated by the system interface 110. Once initiated, the order process and flow of communications is similar to the agent-initiated embodiment. Further, the system interface 110 and/or order distributor 106 may provide store information to, or otherwise alert, one or more alternate remote order taking agents 102 to be ready in case of a failure of communication with the first selected remote order taking agent 102.

In yet another alternate embodiment, the remote order processing system may include a plurality of order distributors 106. Each of the plurality of order distributors 106 may, in turn, be located in different stores or retail locations within a city, different regions and/or sections of the country, to provide redundancy or to serve different stores and restaurants or subsets thereof. The order distributor 106 may include a switch, router, computer programmed to distribute orders, or any suitable device to distribute orders or combinations thereof. The order distributor 106 selects a particular remote order taking agent 102 and remote agent terminal 108 to handle an order, making its selection from a plurality of remote order taking agents 102 and associated remote agent terminals 108. This selection may be based on a number of factors as discussed below. The order distributor 106 may further select one or more alternate remote order taking agents 102 so as to anticipate any problems which may prevent use of the first selected remote order taking agent 102. As was described above, in one embodiment, the order distributor 106 receives identification data, at least identifying the store 146 or restaurant where the customer is located, from the system interface 110 via the customer arrival alert 128. This identification data is then transferred to the selected remote agent terminal 108, for example, to inform the remote order taking agent 102 of the location of the customer and/or to cause the terminal 108 to automatically display a store-specific interface menu, or normalized version thereof. The identification data may include a phone number for a call back, an IP address, or a directory address that identifies the store or POS location 104 and can be utilized to establish a connection between the customer and the remote agent terminal 108. In embodiments where the customer arrival alert further includes store information, this store information may be similarly passed to the remote agent terminal 108.

Store information may include data that is likely to change often, i.e., dynamic data, and data which is less likely to change, i.e. static data, or a combination thereof and different store information, or subsets thereof, may be sent in different customer arrival alerts. The order distributor 106 may be coupled with the store database 122 which contains and organizes store information such as, for example, commodity listings, etc., regarding one or more stores 146 in order to manage and avoid re-transmission inefficiencies and maximize and/or conserve bandwidth requirement. In this configuration, upon receiving a request from the order distributor 106 that identifies a particular store 146, the store database 122 can retrieve and transfer the appropriate commodity listing, menu or store information to the order distributor 106 or directly to the selected remote agent terminal 108 via the store data lookup connection 144. Thus, it is unnecessary for the store 146 to provide the same information to the order distributor 106 at the beginning of every communication session. The store database 122 may be a personal computer or a computer storage device such as a hard drive. The store database 122 may be a separate device from the order distributor 106 or may be part of the same device.

As described above, the customer arrival alert signal 128 may include store information which has changed and for which it therefore may be necessary to update the store database 122. Store information may include the current conditions of the store, such as the availability of products, the number of customers waiting, the wait time for a customer at the store, promotion information, such as available coupons, rebates, or sales, or customer language information. For example, individual restaurants may have different menus and the order taker will need to use the correct menu based on the particular restaurant they are servicing. An example of a promotion would be if the retail location is trying to sell a thousand (1000) hamburgers in a single day. That information may need to be sent to the remote agent terminal 108 as discussed below, so the remote order taking agent 102 can notify the customer of the promotion. In the example of a drive-through restaurant, additional store information may include drive-through queue information (the determination of which is described in more detail below), such as the customer back-log, traffic information, weather information, drive-through data, and kitchen queue and/or capacity information for one or more kitchens in the store. For example, if there are ten (10) cars in the drive-through queue, that information would suggest that the order takers need to be extra prompt in receiving and entering the order. Additionally, the kitchen queue and/or capacity information may inform the remote agent terminal 108 that one or more of the kitchens at the store is behind on orders, is having equipment or staffing difficulties, has exhausted the inventory of a particular product and/or product fulfillment is delayed, e.g. the kitchen will not have French fries ready for five minutes, so customers should be notified of the delay in receiving their order if they are planning to order, or have already ordered, French fries. In this case, the remote order taking agent 102 may be trained, or otherwise automatically prompted, to direct the customer to an alternative product choice so as to assist in alleviating the burden on the store or kitchen.

As described above, dynamic data is data that is likely to change for each order while static data is the data that is less likely to change. For example, queue information such as at the drive-through or the kitchen queue may be dynamic data because it is likely to change at any given moment. Static data may include the commodity listing, menu or promotion information, such as available coupons, rebates, or sales, which is less likely to change over a given period of time, such as over the course of a day. In one embodiment, the local or store specific commodity information or store information that is transmitted with the customer arrival alert 128 from the system interface 110 to the order distributor 106 can, in most occurrences, include only dynamic data while the store database 122 maintains the static data such as a baseline commodity listing and store specific commodity listings for each of the plurality of stores, thus eliminating the need to transmit the static data for every customer, order or transaction. Further, should the static data change, only the updated static data needs to be transmitted with a subsequent customer arrival alert 128 to update the store database 122. The relationship between the remote agent terminals 108 and the store database 122 is similar to the relationship between the store database 122 and the system interface 110, i.e. where store information is provided to the remote agent terminals 108, such information may be stored in the remote agent terminals 108 such that this information need only be retransmitted from the order distributor 106/store database 122 if the information has changed.

It will be appreciated that standard principles of data caching, including protocols to minimize missing in the data cache, e.g. minimum data block sizing, maintain data coherency and prevent stale data, may be implemented, including an invalidation protocol, data expiration controls and/or pre-emptive caching of data, e.g. transmitting static data in advance of any order rather than concurrent therewith. Further, P2P distribution protocols may be utilized allowing one remote agent terminal 108 to obtain such data from another remote agent terminal 108 rather than from the order distributor 106/store database 122, such as to provide redundant or otherwise reliable data distribution. In determining when an update is necessary, a table or other database identifies what data has been previously sent and/or received by each of the devices, services, terminals and workstations comprising the system 100, so that the update status of each device can be evaluated and synchronized according to any desirable manual or automatic schedule. Alternatively, the system interface 110 and order distributor 106/store database 122 or order distributor 106/store database 122 and the various remote agent terminals 108 may implement a protocol whereby the data recipient validates its data with the source, such as by sending a conditional request including a checksum, hash value, tag or fingerprint unique to the data which the recipient already has stored which can be verified by the data source to determine if the recipient is presently storing stale data.

### B. System Updating

In one embodiment, customer arrival alerts 128 for a particular retail location or restaurant are transmitted to the order distributor 106 from the system interface 110 including store information that is dynamic but which could include static information has changed subsequent to a prior transmission, such as commodity information. The dynamic data can then be transmitted to the remote agent terminal 108 as required. In this embodiment, the static data, such as the baseline commodity listing or retail menu, does not need to be transmitted with each new alert 128 because the store database 122 maintains a record of all of the static data associated with each retail location, chain of retail locations, etc. The order distributor 106 can retrieve the static data from the store database 122 and transmit it to the remote agent terminal 108 if necessary, e.g. if the remote agent terminal 108 needs to have its copy of the static data updated. However, as noted, the static data may need to be transmitted to the order distributor 106 and to the store database 122 if it has changed, or otherwise been updated or modified. For example, if a store runs out of a particular item, then that may result in a change to the menu. The updated static information is transmitted from the system interface 110 to the order distributor 106 to the store database 122 to update its records. Alternatively, if a retail location decides to discontinue a promotion, such as fifty cent cheeseburgers, then the static information that included this promotion would need to be updated to indicate the promotion has been discontinued. Additionally, for the first transaction for a particular store, all of the static data will likely need to be transmitted to the store database 122 to establish a baseline record of the static data for that store within the store database 122. Alternatively, the static data could be stored in the store database 122 and/or distributed to the remote agent terminals 108 in advance of the first order via an alternative means, such as by a separate dedicated transmission.

Once the order distributor 106 receives a customer arrival alert signal 128/order request from the system interface 110, the order distributor 106 selects a remote order taking agent 102 with an associated remote agent terminal 108 to handle the order. In one embodiment, the remote order taking agent 102 is a human being. In an alternative embodiment, the remote order taking agent 102 may be implemented in software, hardware or a combination thereof, such as an artificial intelligence based interactive voice response system. The remote agent terminal 108 may be a personal computer or computing device with a network connection as discussed below, with the appropriate hardware such as a headset with a microphone and earpiece for a remote order taking agent 102 to interact with, e.g. speak and listen to, a customer. A software program may present the appropriate information to the remote order taking agent 102, such as an on a display coupled with the remote agent terminal 108, to allow the remote order taking agent 102 to properly interact with the customer and receive, validate and enter the order into the remote agent terminal 108. This information may include the list, the menu, the promotions and/or specific POS terminal interface screen stored on the remote agent terminal 108 or provided by the order distributor 106 or system interface 110.

In one embodiment, software is provided which replicates the user interface, i.e., the type, position and arrangement of graphical icons representative of commodities and menu items, etc., of a register located within the actual retail location on the display of the remote agent terminal 108. For example, a customer inside a fast-food restaurant tells an employee at a restaurant what he/she would like to order and the employee enters the information into a register having dedicated keys for the item, as was described above. Likewise, the remote order taking agent 102 is presented with a similar interface having similarly dedicated inputs, such as a set of virtual buttons which mimic the register interface. Alternatively, as will be described in more detail below, the software may unify or normalize the variations in the presentation of commodity listings or menus among the retail locations or stores 146 so as to present a consistent user interface to the agent 102 that reflects the menu variances in an intuitive manner. For example, a chain of related stores 146 may offer a baseline or general menu or commodity listing. This general menu or commodity listing may be displayed on the agent terminal 108 in a standard arrangement or configuration. By presenting a standard arrangement or configuration of the baseline commodity listing or menu, the agent 102 can become familiar with the arrangement which, in turn, will ease and speed up the order entry procedure by negating the need to hunt for commodities requested by the customer. In the event that dynamic data, including variations to the baseline commodity listing or menu items, is communicated to the agent 102 or agent terminal 108, the variations can be displayed within or as a part of/integrated with the standard arrangement. In this way, new or changed information can be provided to the agent 102 without causing confusion or delay in the order entry process. The remote order taking agent 102 receives a customer's order through a data or audio connection and enters that order into the remote agent terminal 108 and the order data is then transmitted back to the store through the data connection as described herein.

The remote order taking agent 102 and remote agent terminal 108 may be located at a variety of locations. Remote order taking agents 102 may be located on-site at the store or POS location 104, or may be located remotely therefrom such as at a remote-order center/call center or located in their home as discussed below. The disclosed embodiments permit the remote order taking agent 102 to be located away from the remote POS location 104 with a data or audio connection established between the customer at the remote POS location 104 and the remote agent terminal 108, as was described above. Further, as remote order taking agents 102 may not be directly or permanently connected with a store 146 or POS location 104, each may handle order requests for a wide variety of stores 146 and/or POS locations 104. For example, individual remote order taking agents 102 may receive orders from a chain of fast food restaurants located across the country. The remote agent terminal 108 may take orders from different restaurant locations or even receive orders from different restaurant chains/brands. Alternatively, it may be advantageous to select order taking agents 102 that are familiar with a particular restaurant or that meet the criteria as discussed below. Order taking agents 102 may be located within the same geographic regions, e.g. city, county, state and/or country, as the store, or in a different geographic region. In one embodiment, order taking agents 102 are located in one or more different time zones so as to be able to provide available order taking agents 102, working during the normal business hours of their location, to take orders at any time of day from any particular store. This permits, for example, twenty-four (24) hour order taking capability without having to pay order taking agents 102 overtime or special pay or otherwise requiring them to work beyond their normal business/working hours.

In one embodiment, there may be a remote order center (“ROC”), also referred to as a remote call center (not shown) that houses a number of remote order taking agents 102. The remote order center may include an order distributor 106 which receives customer arrival alerts 128/order requests that may specify a specific remote order taking agent 102 or the remote order center or order distributor 106 may choose an appropriate remote order taking agent 102. The remote order center may include its own order distributor 106, or the order distributor 106 may be located outside of the remote order center. The remote order center may house a number of remote agent terminals 108 wherein the order distributor 106 selects a remote agent terminal 108 based on the characteristics of the remote order taking agents 102 working at the remote order center, or some other parameters. In an alternate embodiment, the remote agent terminal 108 and the remote order taking agent 102 may be located at home and suitably in communication with an order distributor 106, such as via a digital subscriber line (“DSL”), cable modem, dial-up or wireless connection. More information related to locating remote order taking agents 102 remotely from call centers may be found in related U.S. patent application Ser. No. 11/528,819 (12764-00008), captioned above.

In one embodiment, the order distributor 106 selects a remote order taking agent 102 that is appropriate to handle the particular order. This selection may be based on the identification information and/or store information provided with the arrival alert 128 and/or retrieved from the store database 122 and further based on profile information, known or provided to the order distributor 106, regarding the various available remote order taking agents 102. For example, selection of a remote order taking agent 102 may be based on agent availability, store or menu familiarity, historical experience with the particular store, production demand, expertise, regional, cultural or linguistic compatibility or capability, order taking speed, order taking accuracy, agent seniority, rating (schedule adherence, etc.) or combinations thereof. Some selection criteria may be absolute requirements, such as language compatibility, while other criteria are merely preferential, such as cultural compatibility. In selecting a remote order taking agent 102, preferential criteria may be suppressed or otherwise de-prioritized when production demand is high and agent availability is low. For example, for a restaurant in Chicago, an order taker may be chosen who has a Midwestern or Chicago accent. A customer in the Midwest may ask about which “pops” are available, however, in the South, the customers' may instead use the term “sodas.” These regional/cultural differences may be considered when selecting a remote order taking agent 102 and the associated remote agent terminal 108. Likewise, if a store is located in the South, an order taker with a Southern accent may be preferred. The order distributor 106 may have access to a directory, for example maintained in the order distributor 106, of any potential remote order taking agents 102, which includes data on the availability of the remote order taking agents 102 and information regarding their capabilities or training such as language, dialect, and familiarity with individual stores. This directory may be updated in real time to reflect remote order taking agent 102 availability or capabilities. For example, the remote agent terminals 108 may feature attendance tracking software which determines whether the remote order taking agent 102 is physically available and prepared to take orders via their respective remote agent terminal 108 by, for example, requiring the agent 102 to log in and out. The order distributor 106 may first select an remote order taking agent 102 based on the availability information and secondarily on other factors as described. For example, if an remote order taking agent 102 needs to take a lunch break, then the agent 102 may notify the order distributor 106 that he/she is currently unavailable and the order distributor 106 will not select that remote order taking agent 102 until the order distributor 106 receives a notification, i.e. the directory is updated, that the remote order taking agent 102 is back and that remote agent terminal 108 is again available. More information related to order taking agent 102 selection may be found in related U.S. patent application Ser. No. 11/512,899 (12764-00005), captioned above.

As described above, individual remote order taking agents 102 may already have commodity listings related to each retail location or store 146 stored in their remote agent terminal 108, either pre-loaded or as a result of handling a prior order from that same store, which may influence the selection of that remote order taking agent 102. This information may be reflected in the directory described above. If the remote order taking agent 102 has already handled a prior order for a particular restaurant or retail location, then he/she may be selected to receive subsequent orders from that same restaurant because new store information does not need to be transmitted to the associated remote agent terminal 108, saving time in readying the remote order taking agent 102 to take the order. As discussed above, the store database 122 or the order distributor 106 may be storing static data for a particular store, which may be transmitted to the remote agent terminal 108 the first time that remote agent terminal 108 is selected to handle an order for that particular store. Subsequently, a remote agent terminal 108 with the appropriate static data will not need to receive the same data again, unless, as described, that data has changed. Therefore, the order distributor 106 does not need to retrieve the static data for the store from the store database 122 and does not need to transmit that data to the remote agent terminal 108. Accordingly, the order distributor 106 is likely to choose a remote agent terminal 108 that already has the static data for the particular store. As discussed above, the remote agent terminal 108 may still receive the dynamic data or any updates or changes to the static data just as the order distributor 106 receives that data. The selection of a remote order taking agent 102 that already has the static data for a particular store results in less data being transferred to the remote agent terminal 108, which may result in a quicker and more efficient response. Further, a remote order taking agent 102 that has taken previous orders from the store is likely familiar with the store and its offered commodities, menu items or products and, having received multiple orders from the same store, is likely to be more efficient at receiving and entering the order. Where the static data has changed, the order distributor 106 may ignore or de-prioritize the historical experience of the order taking agent 102 with respect to that particular store 146 as a selection criterion since the transmission of the static data will negate the advantage in selecting that particular remote order taking agent 102. Alternatively, historical experience may still be relied on even if the static data needs to be transmitted as that agent 102's prior experience/familiarity with the particular store and/or menu may be advantageous despite that there may be delay in providing the static data.

Once a remote order taking agent 102 and associated remote agent terminal 108 is selected, the order distributor 106 transmits an order initiation signal 130 to the selected remote agent terminal 108 that may include the customer arrival alert signal 128 and additional store information, such as the store information, static data, or dynamic data as discussed above. For example, if a restaurant is offering cheeseburgers for one dollar ($1), then that information will be transmitted to the selected remote agent terminal 108 along with the order initiation signal 130 as static data if this is the first time the remote agent terminal 108 has received an order from that restaurant. Subsequently, when the same remote agent terminal 108 receives a subsequent order initiation signal 130 indicating an order from that store 146, the cheeseburgers-for-$1 information will not be transmitted to the remote agent terminal 108 because the remote agent terminal 108 already has that information. The remote agent terminal 108 may maintain a record of the static data for all future orders from that store 146. If the store 146 were to run out of hamburgers or cancel the sale, then the static data will need to be updated. Consequently, the next order initiation signal 130 received will include an update to the static information either canceling the promotion or updating the menu to show that hamburgers are unavailable. As discussed above, the order initiation signal 130, in the agent initiated embodiment, will cause the remote agent terminal 108 to initiate the connection with the system interface 110 and/or remote POS location 104. Alternatively, in the store interface initiated embodiment, the order initiation signal 130 may alert the remote agent terminal 108 of the expected session initiation by the system interface 110 or, alternatively, the order initiation signal 130 may come from the system interface 110 as part of the session initiation.

In an alternate embodiment, the static data is updated in the store database 122 and not with the remote agent terminal 108, where the remote agent terminal 108 receives all of the static and dynamic data with each order initiation signal 130. Such a scenario may be necessary if, for example, the order distributor 106 oversees a very large number of stores and remote order taking agents 102. The system may function more efficiently by choosing remote order taking agents 102 based only on availability. In this embodiment, the dynamic data and the static data is transmitted to the remote agent terminal 108 for each order from each store 146. Accordingly, the remote agent terminal 108 would not need to record the static data for individual stores because that data is transmitted for each order.

The order initiation signal 130 from the order distributor 106 to the selected remote agent terminal 108 may also include contact information for the store, which the remote order taking agent 102 and/or remote agent terminal 108 may use to establish a connection with the store and specifically, a connection with the customer. The selected remote agent terminal 108 may then send a session request 132 to the system interface 110, or alternatively, specifically to the speaker post 112.

### C. Alternative System Embodiments

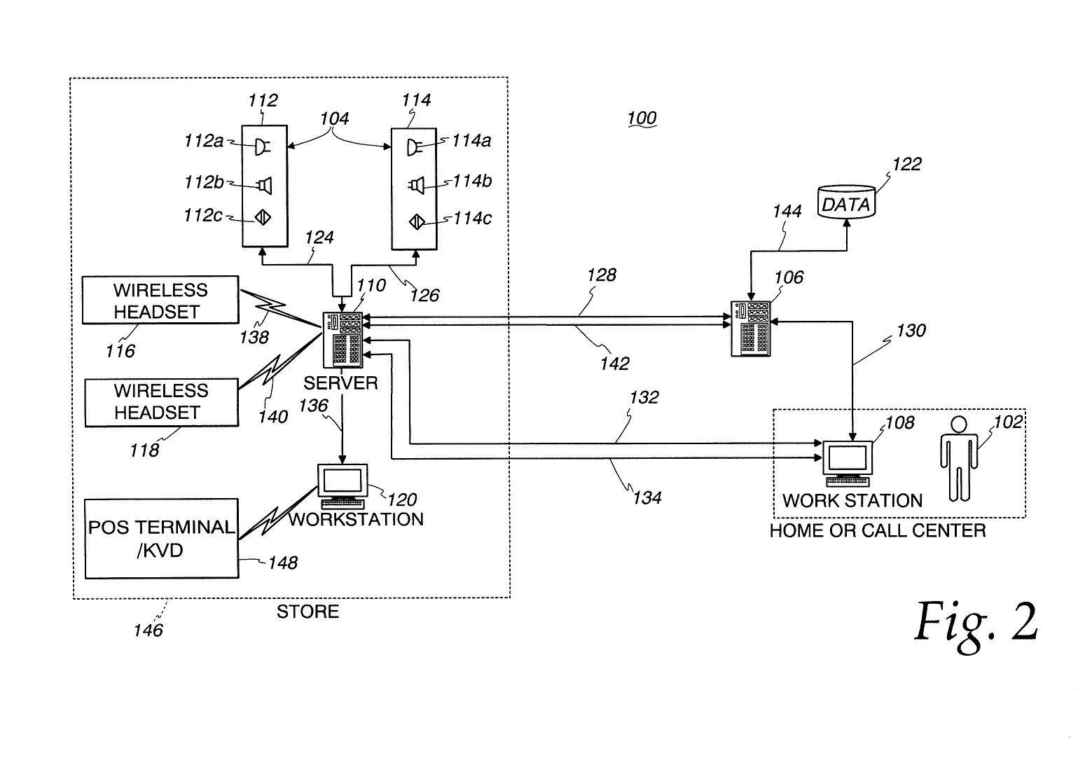

FIG. 2 illustrates an alternate embodiment of the order processing system 100 in which the system interface 110 is configured to send a session request 142 to the order distributor 106 or to the selected remote agent terminal 108, rather than the selected remote agent terminal 108 sending a session request 132. The session request 142, 132 is an attempt to establish a session between the customer at the speaker post 112, 114 or store 146 and the selected remote agent terminal 108. During this session, there may be multiple connections established between the customer or remote POS location 104 and the selected remote agent terminal 108 for different purposes, such as a data connection for the transmission of an order and an audio connection allowing the customer to speak with the remote order taking agent 102. For example, an order data connection 134 may be established by the selected remote agent terminal 108 to transmit the order to the store or RPOS system 120 through the system interface 110. The audio connection may be substantially simultaneously established through a standard phone line or a VoIP connection. The customer talks into the speaker post 112, 114 through the audio connection with the selected remote order taking agent 102 for communicating the commodities or order components the customer would like to order to the remote order taking agent 102 who enters them into the remote agent terminal 108. Where the audio connection is a VoIP connection, it may share the same session as the order data session 134. In other words, the audio data may be transmitted along with the order data.

For example, the customer at a drive-through POS location 104 is connected through some form of an audio connection via the speaker post 112, 114 with a selected remote order taking agent 102. The customer is prompted by the remote order taking agent 102 for their order and the customer then tells or otherwise provides the remote order taking agent 102 what items/order components he/she would like to order, this being communicated to the remote order taking agent 102. As the remote order taking agent 102 hears the customer articulate each desired commodity, the remote order taking agent 102 inputs the ordered commodity or component into their remote agent terminal 108, such as via a virtually generated store-specific-POS-terminal-interface or normalized interface, as discussed above. The entry of an order component into the remote agent terminal 108, as it is entered by the remote order taking agent 102, causes the generation of order data identifying the ordered order component and the transmission of that order data to the store or system interface 110.

Alternatively, two or more order components or commodities may be grouped together for transmission, such as where the order components are received and entered into the remote agent terminal 108 within a specified period of time, e.g. within 200 milliseconds of each other. It will be appreciated that the grouping of order components for transmission back to the store or system interface 110 is implementation dependent and that the decision to hold the transmission of one or more order components so that they can be grouped depends on balancing communication efficiency with the maintenance of at least the illusion of real time feed back to the customer and/or not inhibiting the order fulfillment process of the store, as described herein. In one embodiment, as the order data is received from the remote agent terminal 108, the order data may be provided to a display proximate to the speaker post 112, 114 such that the customer may see a display of the items or components that the remote order taking agent 102 has already entered, the display being updated as the order components are entered. This operation is performed substantially in real-time, to give the customer the sense of an interactive experience, allow the customer to acknowledge the accuracy of the order, allow the customer to detect any errors as soon as possible and/or simply to prompt the customer to reflect on his decisions. The customer may then inform the remote order taking agent 102 if there are any errors or if the customer would like to change any of the order components or items in the order. Alternatively, if there is no display screen for the customer, the remote order taking agent 102 may audibly repeat the order via the speaker post 112, 114 so the customer can acknowledge that it is correct. When the remote order taking agent 102 finishes entering the order components and the customer has no more items to order, the remote order taking agent 102 may inform the customer of the total price, offer any discounts, upsells, cross-sells or otherwise announce any promotions or informational messages, and further may inform the customer where to go to pay and/or pick up the ordered items. The connection/session is then ended and the remote order taking agent 102 becomes available to take an order from another customer from the same or another store.

The store's RPOS system 120, also is coupled with the system interface 110, as described above, and operative to receive customer or order information including receiving the order data, substantially as it is entered by the remote order taking agent 102 and transmitted to the system interface 110, for the purposes of fulfilling the order and otherwise integrating the order into the store's workflow, e.g. inventory management, etc. The RPOS system 120 may be located within the store at the POS location. In one embodiment, the store's RPOS system 120 is coupled with the communication network within a store and may include connections with the system interface 110. As discussed, the RPOS system 120 may include the POS terminals, e.g. cash registers within a store and other order fulfillment stations, such as KVS's, as well as the POS server 90.

In one embodiment, the RPOS system 120 may receive an order from the remote agent terminal 108 through an order connection 136 and the system interface 110, rather than an employee at the store entering the order into a POS terminal. The RPOS system 120 can transmit the order to at least one POS terminal 148, which an on-site employee then uses for fulfillment of the order and for collecting payment. In one embodiment, the store 146 may have POS terminals 148 as part of the RPOS system 120, some of which receive orders from a remote agent terminal 108, and others, which receive orders from on-site employees.

For example, the POS terminal 148 in the RPOS system 120 may display the order components and the price for the items. An employee at the store 146 or the store register then makes/manufactures/prepares the order components or instructs them to be made, or otherwise gathers them into a complete order to be given to the customer. The employee then requests the payment from the customer based on the amount shown by the POS terminal 148. The POS terminal 148 may then further be used to receive payment, such as by credit card or cash. Once payment is received the order is fulfilled, and the POS terminal 148 can receive the next order.

As described, in response to a customer arrival signal 124, 126 indicating the presence of a customer waiting to place an order, the system interface 110 sends a customer arrival alert 128 to the order distributor 106 which then selects an appropriate remote agent terminal 108 to initiate a session with the system interface 110 for the purposes of transmitting order data back to the system interface 110 and substantially simultaneously establishing an audio connection for the purpose of receiving the order from, or otherwise communicating with, the customer. While the mode of the audio connection may vary, the failure to establish such a connection is important to determine as soon as possible so as to enact fail over mechanisms as quickly as possible to handle the customer's order. In particular, in one embodiment, should a failure to establish the session, the audio connection, or both, occur, the system 100 automatically detects the failure and enacts a fail over mechanism to handle the order. In this way, the customer's order, and the fulfillment thereof, is prioritized. Further, incomplete connections are avoided because an audio connection between the customer and the remote order taking agent 102 would not be established when the remote order taking agent 102 has no way to transmit the order back to the system interface 110, as such a situation wastes the order taking agent's 102 time and promotes customer frustration. In failure situations, the system 100 may select an alternate remote agent 102 to handle the order or defer to the personnel at the store to take the order. In particular, where the system 100 is able to determine that the problem is with the specific agent 102, another agent 102 would then be selected. However, where the problem is preventing connections with any remote order taking agents 102, then the system 100 directs the order to be handled at the store.

The wired or wireless headsets 116, 118 are operative to establish an audio connection with a customer at the speaker posts 112, 114. In one embodiment, each headset is associated with a speaker post 112, 114 and permits the wearer to listen in and/or participate in any communications occurring with the speaker post 112, 114, such as an order being handled by a remote order taking agent 102. The headsets 116, 118 may connect with the system interface 110 through failover connections 138 and 140, respectively, described in more detail below. The system interface 110 is coupled with the speaker posts 112 and 114. The headsets 116, 118 have a microphone and speaker for communicating with the customer. The speaker may be an earpiece or headphones. In an alternate embodiment, the headsets 116, 118 may be wired within the store to establish a wired connection with the speaker post or with the system interface 110.

If the connections 130, 132 or 134 between the remote order taking agent 102 or the order distributor 106 and the system interface 110 were to fail for any reason, then the system 100 must have a backup or fail-safe plan for receiving customer's orders, as was described. If either the audio or data connection fails, then the order may be received by employees within the store 146 via the headsets 116, 118. If the audio connection fails, then the customer and the remote order taking agent 102 would be unable to communicate. If the data connection fails, then the remote order taking agent 102 would be unable to transmit the order data to the store 146. In either circumstance, the order taking responsibility reverts back to the store 146 and employees, with headsets 116, 118, who can then communicate with the system interface 110 through the failover connections 138, 140 which take over the communication, either automatically or via manual intervention. The headsets 116, 118 allow an employee to establish audio contact with the customer to receive the customer's order. The employee may then enter the order into the RPOS system 120, in one embodiment, picking up where the remote order taking agent 102 left off based on the order data transmitted thus far, as displayed on the POS terminal 148, before the failure or reenter the complete order. Similarly, if an alternate remote order taking agent 102 is selected to take over the order, they may also be provided with the present status of the order so as to be able to pick up where the previous remote order taking agent 102 left off.

For example, when the fail safe mode is activated, the order components that have already been transmitted by the remote order taking agent 102 are already entered into the RPOS system 120. For example, a customer at a drive-through says “I would like to order two cheeseburgers and large fries.” The selected order taker enters two (2) cheeseburgers and that data is transmitted to the store or interface, however, the data connection or audio connection then fails. The fail safe mode is activated with part of the order already entered, e.g., two cheeseburgers have already been recorded and received by the restaurant. An employee with a wireless headset 116 then establishes an audio connection with the customer in the drive-through, determines, from the POS terminal 148, what has been ordered thus far, and says “I have 2 cheeseburgers for you, would you like anything else?” The customer can then finish the order with the employee entering the remainder of the order into the POS terminal 148. In this way, the customer may never be aware that a failure occurred, maintaining customer satisfaction and confidence.

In one embodiment, the remote order processing system 100 is part of/owned and operated by an overall order processing system of a restaurant or chain of restaurants. In an alternative embodiment, the remote order processing system 100 is provided as a service to one or more restaurants and/or restaurant chains. This service may be provided on a subscription or fixed fee basis, such as a monthly or yearly fee, basis, on a per-order/transaction basis, on a time basis, such as per minute or per second charge measured over the total time of the transaction or multiple transactions over a defined period, or combinations thereof. The time basis may be established to reflect the duration of the call or transaction such that longer, and presumably more complicated a transactions, are charged at a higher rate than shorter, simpler transactions. In one example, a restaurant or restaurant chain may contract with such a service to handle all orders or a fixed number of orders over a set period, such as one (1) year, such as to supplement an existing order taking mechanism. Alternatively, a restaurant or restaurant chain may contract with the service to handle overflow orders, such as those order which exceed the restaurant's or chain's own order taking capacity, e.g. lunch or dinner rush or during staffing shortages, weekends, holidays, etc. In an alternative embodiment, the fees charged may be fixed, or variable, such as based on, time of day, day of week, volume of orders or based on the value of the orders handled, e.g. based on gross or net margin, thereby incentivising the service to sell more products and/or more profitable products to customers. In one embodiment where a fee is charged per second, or some other period, of the transaction time, the rate may diminish or go up as the transaction takes longer to encourage fast and efficient order taking, i.e. the first few seconds are more expensive then the later seconds of the transaction, etc. It will be appreciated that the above methods of compensation may be combined to create a pricing system which meets the mutual needs of the service provider and the customers. To implement the particular fee structure, software may be included in the system interface 110 and/or order distributor 106, or elsewhere within the system 100, such as in a separate device, which monitors and/or records the appropriate parameters for billing purposes. The acquired data may then be provided to the service provider, such as to a billing server which handles the billing/accounting functions. Mechanisms may further be provided to allow service subscribers to monitor account/billing activity for audit or other purposes.

### II. System Operation and Interface

The remote order processing system 100 described above in Section I includes embodiments directed to taking, processing and fulfilling orders both from within the retail location or store 146 and remotely from a centralized call center or work at home location. The following section(s) describes exemplary tools and mechanisms such as, for example, the graphical user interface that may be utilized throughout the order taking process. Moreover, the following section(s) provides one or more exemplary scenarios in which these potential tools and mechanisms may be utilized to facilitate the order-taking and fulfillment process.

A. Interface Setup

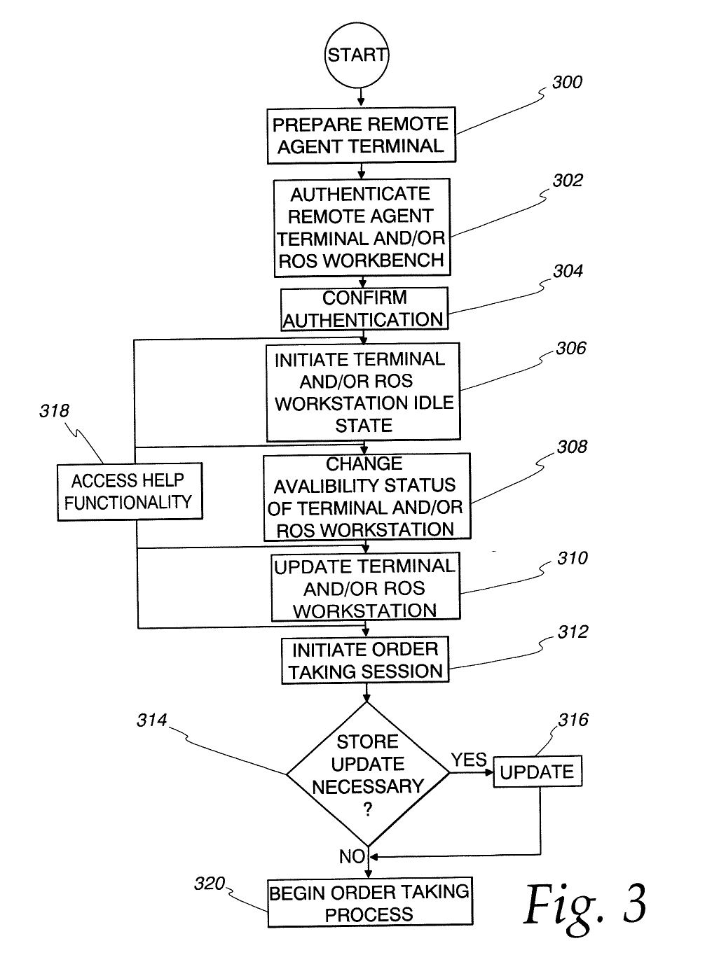

FIG. 3 illustrates the operational steps or procedures that may be undertaken by the agent 102 prior to initiating an order taking session or shift with the store 146 or the order distributor 106. At block 300, the agent 102 can power-up or otherwise activate the remote order taking terminal 108. The power-up sequence could simply be engaging a power switch to provide electrical current to the components of a computer system. Alternatively, the power-up sequence could involve awakening the computer system from a Stand-by or Hibernating state. In these states some or all of the components of the computer system have been disabled or powered down in order to save power or otherwise reduce system activity.

At block 302, the agent 102 authenticates or confirms their identity and/or permission to utilize remote order taking terminal 108 and the tools contained thereon. For example, the agent 102 can, when prompted by the operating system, the order taking software executing, for example, on the terminal 108, or another program operating in conjunction with the operating system, provide authentication information. The authentication information may, for example, be a username and a password, biometric information such as a finger print and/or other coded information provided by, for example, a magnetic or radio frequency identification (RFID) card. The authentication can be further utilized as a part of an activity log to determine who and when individuals or agents 102 are signed-on and utilizing the remote order processing system 100.

At block 304, the operating system can confirm the validity of the authentication information and unlock the functionality of the remote order taking terminal 108. Alternatively, the operating system and the remote order taking terminal 108 may be active, and the authentication information may be communicated via, for example, the internet to the order distributor 106 and/or the order interface system 110. If the authentication information is confirmed and accepted by the order distributor 106 and/or the order interface system 110, the agent 102 may be allowed to interact with the remote order processing system 100 and components. If, however, the authentication information is invalid or cannot be confirmed, an error message may be generated and provided to the agent 102. The error message may request verification of the authentication information or may indicate that the system is unavailable. Repeated errors may lock the remote order taking terminal 108 and may be used to inform a supervisor or the order distributor 106 that a security violation may be in progress.

At block 306, assuming that authentication is confirmed and accepted, the agent 102 may access the terminal 108 and the remote order processing system 100. The confirmed authentication allows the agent 102 to engage in idle state activities. The idle state occurs when the agent 102 is not actively taking orders via the order system interface 110 and POS location 104, or when remote order center (“ROC”) or remote order system (“ROS”) interface or “ROS Workbench” is active but the agent 102 has not started their shift or indicated they are available for order taking. Alternatively, the agent 102 may undergo additional training or instruction while the terminal 108 is maintained in the idle state.

At block 308, the agent 102 can indicate their availability to receive orders to the order system interface 110 and the order distributor 106. Conversely, if the agent 102 is actively taking orders, the order distributor 106 can be instructed to halt further calls to the agent 102 after the termination of the current, active call or order. Thus, if the agent 102 is due for a break, the order distributor 106 can be instructed to switch the terminal 108 to the idle state once the current order is completed thereby preemptively blocking further calls.

At block 310, the order distributor 106 and/or the store database 122 can provide updated static data to the terminal 108, as generally described in Section I-B. The static data may include commodity listings such as: (i) new menus; (ii) new menu icons and images; (iii) updated pricing guides; (iv) updated promotion information; (v) new or offered services, or (vi) or any other business rule or software related updates or information. It will be understood that static information update may be accomplished virtually any time after the agent 102 is authenticated and in communication with the order distributor 106 and/or the store database 122 via the remote order taking terminal 108. Thus, in this embodiment, the store database 122 can include a baseline commodity listing that is representative of all of the commodities, menu items, products and services that are typically offered by the store 146 or retail location. In addition, if the store 146 or retail location includes or provides specialized or unique commodities or items, the store database 122 can includes this information as well.

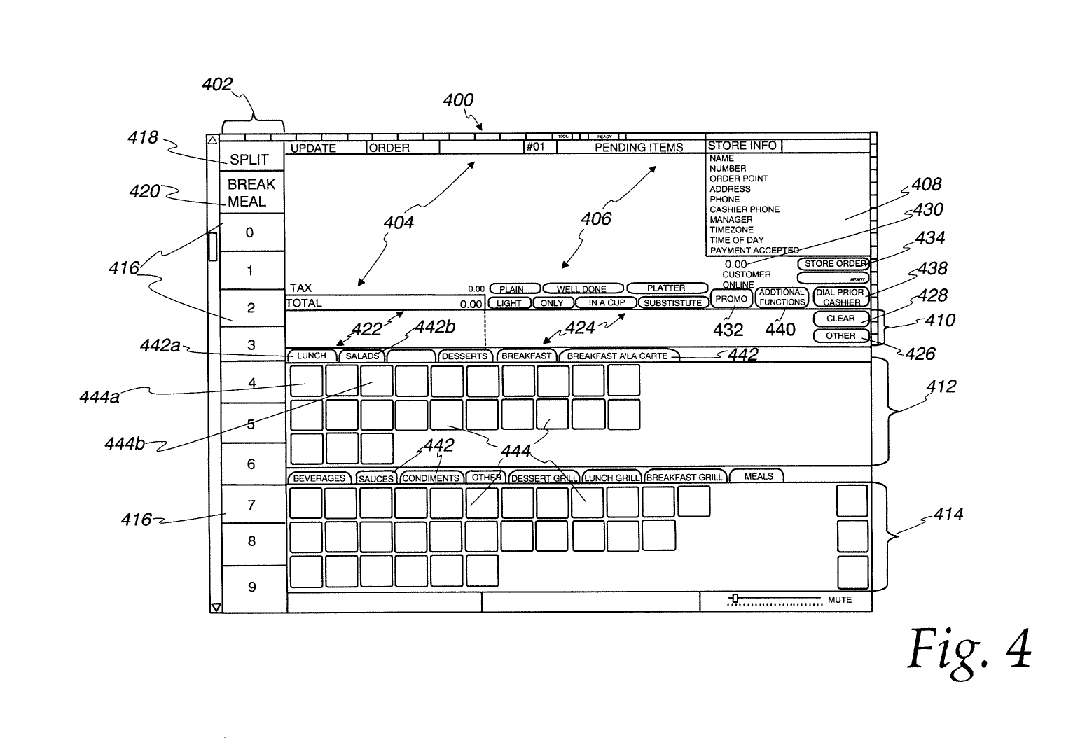

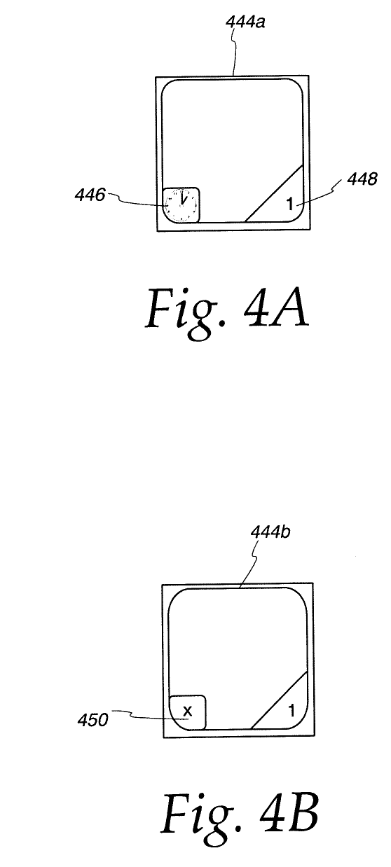

At block 312, the remote order system interface 110 can route the customer order request or arrival alert 128 to the order distributor 106. The order distributor 106 can, in turn, generate the initiate order command 130 and connect the remote order taking terminal 108 to the customer via the speaker post 112. In this way, the agent 102 can begin communicating directly with the customer to conduct an order taking session, as was described above. To facilitate this order taking process, the agent 102 is presented with a unified or otherwise normalized graphical user interface (GUI) 400 (see FIG. 4) configured to streamline the order taking process. As discussed above, the unified or normalized display typically provides the agent 102 with all of the information or baseline commodity listings related to the store 146 or related group of stores 146. In addition, the specialized or variable commodities offered by the store 146 from which the arrival alert 128 originated can be integrated into the normalized display. The normalized display will typically be configured in a standard layout or arrangement to promote agent familiarity, e.g., to be user friendly, and will include the variations or variable commodities as a part of the standard layout. The integration may include removing the focus of one or more graphical icons displayed by the normalized display, graying-out the icon (see FIGS. 4A and 4B), including new commodities on a specialized tab, or combinations thereof, as will be discussed in more detail below.

At block 314, the RPOS system 120 located within the store 146, or communicatively connected with multiple related stores, can query the store database 122 to determine if the store information is up-to-date. For example, the store information can be periodically uploaded from the RPOS system 120 to the store database 122 for regular distribution as part of the static data communication.

However, at block 316, if changes have been made at the RPOS system 120 that are not reflected within the information resident on the store database 120, the order distributor 106, system interface 110 or other appropriately configured device can distribute or communicate these changes to the remote order taking terminal 108 as part of the dynamic data communication. In other words, updated or synchronized data can be provided to the agent 102 prior to the initiation of order taking or processing session with a customer.

At a block 318, or at any other desirable time within the order taking process, the agent 102 may access a help or chat system. For example, during the idle state at block 306 or after an order has been complete for a customer, the agent 102 can access a chat or instant messaging feature to contact an ROS supervisor (not shown). A chat window can be generated that provides a textual interface between the agent 102 and their ROS supervisor. The chat window can be configured to operate in the background of the order processing system 100 to allow the agent 102 to continue to service and communicate with customers until the ROS supervisor responds to their query. In this way, help can be requested and provided without diminishing the efficiency or ability of the agent 102 to continue servicing customers. In one example, requests made to the ROS supervisor can be routed directly to the supervisor's email address, instant messaging address and/or to their wireless device, if they are currently unavailable and the supervisor's availability status can be conveyed or returned to the agent 102.

The help system or interface can further be utilized to convey sudden or urgent product or store changes during an ongoing order processing session, by providing information to the agent 102 via a pop-up screen or interface or other type of display designed to catch the attention of the agent 102. These product or store changes could include sudden product promotions, product outages, equipment failures such as an indication that the grill or fryer is unavailable, or any other information that could impact the customer's order. To prevent unnecessarily confusing or distracting the agent 102 during an order taking session, these sudden updates can be prioritized and delivered to the agent 102 during the session, after completion of the session or as a part of the scheduled dynamic data update prior to the initiation of the next session. Failure to complete these urgent updates, depending on the priority assigned thereto, could result in customer calls being re-queued or re-distributed by the order distributor 110 to an agent 102 in possession of the urgent information, or reverted back the store 146 to be handled.

At a block 320, the updated and connected remote order taking terminal 108 can prompt the agent 102 to begin the order taking process.

B. Order Taking

FIG. 4 illustrates one embodiment of the unified or normalized GUI 400 configured to display a baseline commodity listing such as, for example, menu items, promotional information such as cross selling opportunities and special menu items, nutritional information, etc. The commodities or information displayed via the GUI 400 can be organized and arranged to reflect retail items provided by any one of a plurality of stores 146. This organized and arranged information assists the agent 102 in providing detailed and accurate service to the customer during an order taking session. It will be understood that the aesthetic design of the GUI 400 is implementation dependent and all arrangements and presentations of graphics or text based interface elements which achieves the disclosed functionality are contemplated.

The exemplary GUI 400 is configured for use during an order processing session. The GUI 400 includes: (i) a numeric keypad 402; (ii) a current order window 404; (iii) an action or pending item window 406; (iv) a data window 408; (v) an options bar 410; (vi) a menu section 412; and (vii) a secondary menu section 414. The sections of the graphical user interface can be displayed on the cathode ray tube (CRT) or LCD monitor connected to the order taking terminal 108 at a size and resolution such as, for example, 1152×864, determined to easily display the required order information and options. Moreover, the GUI 400 and the included sections can be configured to mirror the POS terminal interface used within the store 146. Alternate system configurations could employ a touch screen coupled to the LCD monitor thereby allowing the agent 102 to physically interact with the GUI 400 in a manner similar to an order taker physically located within the store 146. In yet another alternate configuration, the GUI 400 may cooperate with and/or be controlled by shortcuts and keystrokes provided via a keyboard (not shown) attached to the remote agent terminal 108. For example, the order taking agent 102 may select the control (CTRL) key to view additional information such as pricing, nutritional facts, etc., associated with identified products. It will be understood that other keystrokes and keystroke combinations may be predefined or customized to facilitate access to the functionality represented by the GUI 400.

The GUI 400, as discussed herein, is displayed on a two-dimensional monitor which is, in turn, connected to the order taking terminal 108. Directions such as top, bottom, left and right, as used herein, are intended to refer to upper, lower, left and right portions of the GUI 400 as it is displayed to the agent 102. While these size, location and arrangement of items and section comprising the GUI 400 are consistent throughout these descriptions, these elements are presented as merely one example of a user interface that could be constructed to perform these order taking functions. It will be understood that different configurations and arrangements of the GUI 400 could be devised while maintaining and reflecting the teaching and disclosure presented herein. Further, it will be appreciated that the aesthetic aspects of the GUI 400, such as the pictures utilized, fonts or the colors, etc. are implementation dependent, such as the use of a corporate color scheme or the use of trademarked product names as icon representations of those products.

The numeric keypad 402 is vertically arranged along the left hand side of the GUI 400. The numeric keypad 402 includes buttons or icons representing the numeral zero to nine, generally indicated by the numeral buttons 416. These buttons allow the agent 102 to select or identify the number of items, meals, promotional codes, prices, etc. during the course of the order taking process. The numeric keypad 402 further includes: a split button 418 and a break meal button 420. The split button 418 allows the agent 102 to separate multiple quantified products such as, for example, three (3) cheeseburgers, into one or more rows to allow the them to be grilled, e.g., to allow the properties and attributes of the cheeseburgers, or adjusted independently. The break meal button 420 separates the individual items of the meal, e.g., the hamburger, fries and drink, into individual components with separate pricing. In other words, the discounted meal which typically includes a pre-selected sandwich, fries and size of drink can be broken down into individual items if the customer decides they no longer want the meal or would like to make specific modification thereto.

The current order window 404, the pending item window 406 and the data window 408 occupy the top third of the GUI 400. The current order window 404 is the leftmost window, the pending item window 404 is the center or central window and the data window 408 is the right most window. During an order taking session, when the agent 102 is viewing the LCD monitor connected to the remote order taking terminal 108, the current order window 404, the pending item window 406 and the data window 408 are arranged at eye-level for easy viewing. This elevated or eye-level position arranges the important, and ever-changing, call and order-specific information presented within the windows 404 to 408 in a prominent location for use by the agent 102.

The current order window 404 is configured to provide a list of the ordered items, the meals, the drinks and the accessories such as promotional toys, newspapers or other items, requested by the customer and entered by the agent 102. These items can be arranged in an outline format wherein a meal heading or identifier occupies a first level and the individual component identifiers that comprise the meal are grouped under the meal identifier at a second level. Moreover, these items can be color coded, utilize different fonts, accents, highlights, indicators, or combinations thereof, to indicate their status, whether or not additional information is required, e.g., the size of an item, whether special handling is required or any other designated characteristic of the order or item. The current order window further includes a running subtotal with tax information, surcharges, processing fees, etc. It will be understood that the tax information could be provided to the remote order terminal 108 via either the static or dynamic data communications in order to reflect the current local taxes imposed at each of the store 146 locations for which the agent 102 is in communication with during a shift.

The pending item window 406 is configured to display detailed information related to an item currently being ordered or discussed between the customer and the agent 102. For example, if the customer, via the post 112 and the remote order system interface 110, requests a chicken sandwich, the item is listed in the current order windows 404 and the outstanding or unanswered questions related to that item are displayed in the pending items window. For this example, the chicken sandwich could come in a grilled or fried style, and the agent 102 is prompted via an information request displayed in the pending item window 406 or a pop-up window to query the customer. Thus, the GUI 400 is configured or programmed to ensure that all of the information needed to complete a customer's order is gather before the completion of the order taking session. Moreover, products within an order may be grouped, reordered or displayed based on the type and status of the individual products, their association with a meal, the item size or any other quantifiable criteria. Alternatively, the pending item window 406 can be utilized to implement or display business rules such as drink logic. Thus, if a customer orders a meal, a message can be displayed in the pending item window 406 instructing the agent 102 to enquire about, for example, the type and size of the drink, the size of the fries, etc.

Moreover, if the customer requests special handling or grilling of an ordered item, the agent 102 can highlight and select the item in the current order window 404 and the option bar 410 will reconfigure for that item. In particular, if a double cheeseburger is selected for special handling, a product build portion 422 of the option bar 410 displays the elements for that item. For example, a double cheeseburger could include: a sesame seed bun, first and second meat patties, ketchup, mustard, onions, and pickle. These components can be listed in any order, but will often be listed based on the frequency at which they are modified. In other words, the more often customer request “no pickles” the more convenient its location will be within the list.

The option bar 410 can further include a grill options portion 424. The grill options portion 424 can include a list, or an abbreviated list, of the frequently used or requested grilling options. The list could include things items or options like extra or no ketchup, extra onions, plain buns and cooking options for meat patties. Alternatively, the agent 102 could select an “other” button 426 arranged within the grill options portion 424. Selection of the “other” button 426 by the agent 102 could cause a complete listing of all the available grill options to be displayed. If an incorrect option is selected or if the customer changes their order, the agent 102 can select a clear button 428 to remove the options associated with the highlighted item displayed in the current order window 404.

The pending item window 406 can be further configured to automatically implement promotions or display scripted business rules established by the store 146, the corporation or any other authorized entity. For example, if a two-for-three dollars business rule or promotion is established for bacon burgers and customer orders two bacon burgers, the pending item window 406 can remind the agent 102 to inform the customer of the special. Alternatively, the business rule or promotion can be automatically applied when two bacon burgers have been ordered and are listed in the current order window 402. Thus, even if a customer is unaware of a promotion, the business rule may be configured to provide them the benefit, and prompt the agent 102 to inform them of the received benefit. It will be understood that if the quantity of bacon burgers is decreased, the business rule and discount may not apply and the customer will be required to pay full price for the items. Other business rules could remind or prompt the agent 102 to up-sell based on: products in current order; time at the restaurant; quantity of items ordered; duration of the call; the particular meal being served, e.g., breakfast, lunch or both; length of the queue. Promotions may further be provided as business rules to automatically prompt the agent 102 and reduce the time necessary to search for applicable promotions when a customer requests information, redemption, etc.

The data window 408 is configured to provide detail order handling information to the agent 102. The data window 408 lists information related to the store 146. The store information could include the store number, location, local time and/or time zone, current weather and temperature and an indication of payment acceptance. The local time/time zone information can be utilized to determine what products are available at a given store 146 location, for example breakfast may be available for a store in the Pacific Time Zone (GMT offset: −8:00) and unavailable at another store in the Eastern Time Zone (GMT offset: −5:00). The data window 408 can further include an order timer window 430 that activates when the call is initiated between the customer and the agent 102, and ends when the final order is submitted to the store 146. The order timer window 430 allows the agent 102 readily manage their performance and gauge whether additional up-selling or customer interaction is called for or if the call is running too long and should be wrapped up. Alternatively, as discussed above, the determination to up-sell may be established as a business rule and communicated to the agent 102 via the action item windows 406. The timer information can also be stored on the order distributor 106, the store database 122 and/or the terminal 108 and used for evaluation purposes.

The data window 408 further includes: a promo button 432; a store order button 434; a go-live after button 436; a dial prior cashier button 438; and an additional function button 440. These additional buttons and options provide nested access to other functionality and subsystems that are integrated into the order processing system 100. For example, if customer needs to cancel an order, the agent 102 can pick the additional function button 440 and select the cancel order command to remove the order form the processing queue. If a customer accidentally gets caught up in the ordering queue in the drive-through, instead of exiting the restaurant, etc., the agent 102 can pick the additional function button 440 and select the skip car command to identify to the store 146 that the car/customer is not associated with a pending order. If a customer queried through the speaker post 112 is determined to have already placed an order through an alternate means, the agent 102 can select the store order button 434 to indicate that the customer's order is already pending thereby skipping to the next customer in the queue and/or terminating the current session. In another scenario, if an error occurs during an order, the agent 102 can pick the additional function button 440 and select the re-queue call command to direct the customer to another agent for completion and satisfaction of their order. In addition, a message can be played to the customer apologizing for the delay and/or error and assuring them that another agent will assist them momentarily.

The promo button 432 allows the agent 102 to reduce the price of a product to zero to accommodate a customer order which is accompanied by a coupon for a free product. The promotion can be applied on all or parts of a product quantity (e.g., two (2) of the three (3) ordered cheeseburgers could be offered as a promotion while the third is charged to full price). The dial prior cashier button 438 allows the agent 102, during the call, to identify that they need to contact the restaurant 146 directly to provide further clarification that is not provided for in the system. The information about the phone number to call is stored on the local agent workstation 108 and is dynamic based on the store 146 for which the agent 102 is taking the order.

The menu section 412 and the secondary menu section 414 occupy the bottom two-thirds of the GUI 400. Both of the menu sections 412, 414 include numerous tabs 442 that display a plurality of icons 444 representative of menu items associated with each tab 442. In the example illustrated by GUI 400, the tab 442a represents the lunch menu and includes icons 444. During an order taking session, when the agent 102 is viewing the LCD monitor connected to the remote order taking terminal 108, the menu sections 412, 414 are may be consistently positioned at the bottom portion of the screen for consistency and ease of use. This consistent position assures that the menu information and items necessary for every store 146 and every ordering session is in a familiar and easily accessible position for use by the agent 102.

The tab 442a, in the present example, represents the lunch menu. Moreover, the tab 442a may be configured to default to an appropriate meal based on, for example, dynamic store data, the time of day or business rules. For example, if an order is received from a location where it is morning, the tab 442 corresponding to “Breakfast” may be defaulted as the active tab 442. In another example, the order may be received from a location where the time is in the afternoon; the lunch menu tab 442b may be set as the default and active tab during this order. The lunch menu includes various the icons 444 that represent menu items such as, for example, hamburgers, cheeseburgers, meals, French fries, etc. These icons 444 are arranged, positioned and otherwise located in a consistent manner within each of the tabs 442 regardless of the restaurant 146 the agent 102 is servicing during a given ordering session. As a result, whenever the agent 102 responds to the initiate order command 130 communicated by the order distributor 106, the GUI 400 presents menu sections 412, 414 that are arranged in a familiar and highly usable manner. For example, because all of the icons 444, e.g., the large meal icon 444a and the cheeseburger icon 444b, are always positioned at the same location on the lunch menu tab 442a, the agent 102 can quickly locate and select these items when a customer places an order. In order to indicate variation or changed in the commodities offered by a given retail location or store 146, the icons 444 may further be modified to provide availability or other information, as shown in FIGS. 4A and 4B.

FIG. 4A depicts a breakfast menu icon 444a that is “grayed-out” to indicate that the item is not available for purchase because, for example, a temporary outage or shortage identified in the store's 146 dynamic data. The icon 444a further includes a clock graphic 446 that denotes that the item is unavailable because of the current time of day at the store 146. The icon 444a further includes a meal identifier 448 that indicates that the item may be purchased as part of a predefined meal at presumably a discounted price, or including a bonus, prize or other promotion. In one embodiment, the meal identifier(s) 448 may be arranged in ascending order, this order may be maintain even if the corresponding product, e.g., a cheeseburger meal or chicken sandwich meal, varies from store 146 to store 146′. Alternatively, the placement of the meal products e.g., a cheeseburger meal or chicken sandwich meal, may be maintained and the meal identifier(s) 448 may be reorganized (in numerical or non-numeric order).

Similarly, FIG. 4B depicts another grayed-out breakfast menu icon 444b that would appear on one of the tabs 442 in order to maintain layout and visual consistency of the tabs but is not available for purchase by the customer. The icon 444b further includes a cross graphic 450 that denotes that the item is unavailable for purchase at the particular store 146 for which the agent 102 is currently processing orders. The icons 444a and 444b may further be configured to include price, size and other modifier information which may, for example, be viewed or activated via predefined keystroke commands. In this way, icons 444 that are typically part of the baseline commodity listing stored on the store database 122 and communicated to the agent terminal 108 are always displayed or provided in standard layout or arrangement; however the availability of these commodities or the icons 444 representative of these commodities can be modified as discussed above.

Alternatively, if the icons 444a and 444b represent special or non-standard items, they may be automatically and dynamically displayed on a predefined tab 442. For example, the “other” tab may be designated to include all non-standard menu items or products associated with a given store 146 or chain of stores 146. In this way, the GUI 400 can be customized to display virtually any item or product.

The tabs 442, which divide the menu sections 412, 414, can organize the menu sections based on a variety of criteria such as, for example, the time if day the menu item is typically consumed, e.g., breakfast or other; the type of menu item, e.g., food, drink, dessert, etc.; the nature of the item, e.g., condiments to be used in conjunction with a menu item, promotion toys or giveaways, newspapers, bottled water, etc. For example, the tab 442b may includes all of the salad and healthy choice options for the menu sections 412, 414. Thus, if a customer orders a salad, the agent 102 simply selects the tab 442b and all of the salad menu item options will be displayed in a single uniform location. Conversely, if a previously ordered salad item is selected in the current order window 404, the tab 442b can be activated and the option bar 410 can display all of the salad components and the most requested grill or modifying options. Similarly, if the tab 442b or a salad item are selected, the tab 442 corresponding to the condiments selection within the secondary menu section 414 may be activated and brought to the foreground to allow for a salad dressing selection.

C. GUI and Menu Normalization

FIG. 5 illustrates an embodiment of a normalization system or operation that may be utilized in conjunction with the Interface Setup and Order Taking procedures discussed in Sections II-A & B. It will be understood that these normalization and configuration steps can be implemented independent of the system start-up procedure or can be implemented in conjunction with the normal operations of the order processing system 100 to reflect changes or updates to the menu selections provided by the store 146.

In this exemplary embodiment, it will be assumed that the start-up steps discussed at the blocks 300 to 304 (See FIG. 3) have been implemented and the ROS terminal 108 is authenticated and on-line.

At block 500, a system user (not shown), manager, programmer, etc. at the store 146 can compile and organize a particular commodity listing, a product list, product group or grouping, or a store menu. The commodity listing or store menu may include standard menu items such as, for example, hamburgers, French fries, chicken sandwiches, drinks, meals, etc. and non-standard menu items. Non-standard menu items or commodities could include any number of food or non-food merchandise sold or provided by the store 146. For example, the store 146 could decide to provide newspapers to morning commuters. Alternatively, the store 146 could provide regional menu items such as southern cuisine, southwestern cuisine, New England clam chowder, etc.

The commodity listing or store menu can further include identification information related to both the standard menu items and the non-standard menu items. For example, if the store 146 decides to provide a tex-mex item, a customized illustration, icon or graphical representation of the item could be created. Alternatively, for a seasonal or non-permanent menu item, text-based icon or identifier could be established and provided.

Pricing information and business rules can be defined and established by the system user to reflect the business environment in which each store 146 operates. For example, prices can be adjusted to reflect, among other things, the popularity of particular menu items, storages or surpluses of the menu item ingredients, or specials and promotions. Business rules can be defined in conjunction with pricing information to, for example, provide a discounted price if two or more of a particular menu item is ordered. Alternatively, a business rule could, for example, identify a product special on a given day of the week or related to a holiday, discounts to be given to senior citizens or AARP members, advise that police officers or other public servants are to be provided with free coffee or soda, and/or advise one the use or availability of coupons that may be in circulation. Other examples of business rules may include, as discussed above, promotions or specials such as, for example, special combo meals, two-for-one purchases, buy-one, get-one free offers, etc.

All of this information, i.e., the store menu, the business rules and pricing information can be formatted by the system user at the store 146 for upload and storage within the store database 122. For example, the remote order interface system 110 and/or the RPOS system 120 can include an information interface (not shown) configured to organize menu information for uploading or communication. The menu information could be provided in a variety of formats such as a text file, comma separated values (CSV) file, a hypertext markup language file (HTML) and/or an extensible markup language file (XML). If an XML file containing the menu information is to be provided to the store database 122, a document type definition file (DTD) or an XML schema should be defined to describe the data within the file. For example, the DTD file could identify a field as <SANDWICH> . . . </SANDWICH>, and the information stored or associated with the field could be HAMBURGER. Additional information could be defined if the menu item is time of day-specific, e.g., it is a lunch or breakfast item, or is a seasonal or promotional item, etc. Thus, any program utilizing the DTD and/or the defined XML Schema would know that the information identified as a hamburger should be grouped or displayed as a sandwich. Further field and/or tags can be defined to describe and organize every item on the store menu and the grilling option or options by which they can be modified.

At block 502, the compiled and formatted store menu or retail location-specific commodity listing can be uploaded or communicated via the remote order interface system 110 to the store database 122. This formatted commodity listing or store menu is, in turn, stored and associated with the store 146 or group of stores from which it originated. This store-specific commodity information can be periodically updated by the store 146, corporate headquarters, regional distributors, etc. to reflect current menu or baseline commodity selections, pricing structures or promotions. Moreover, the information can be monitored and compared to the information stored locally on the each remote order taking terminal 108. Changes, updates or modification to the commodity listing or menu information can be pushed down from the store database 122 to terminal 108 during the static data communication described at block 310 (See FIG. 3).

At block 504, the remote order processing system 100 is configured to process and accept orders from a customer via the drive-up speaker post 112, 114 or an internal RPOS terminal 120. As described at block 312, the arrival of the customer at the speaker post 112, 114 alerts the remote order system interface 110 and the order distributor 106. The order distributor 106, in turn, identifies an available remote order taking terminal 108 and agent 102. Agent availability can be determined based on idle status, training, physical location relative to the store 146, geographic indicia such as accent or regional dialect, and any of the other factors previously discussed.

At block 506, as previously described at block 314, the retail location-specific or remote commodity information such as, the store information and/or the store menu (generally referred to as “the local information”), stored on the remote order system interface 110 and/or the RPOS system 120 can be compared to the baseline commodity listing stored on the store database 122 (generally referred to as “the server information”) and accessible through the order distributor 106. The differences between the remote commodity listing portion of the local information and baseline or store-specific commodity listing portion of the server information represent changes that can occur in the time frame between the regularly scheduled static data communication and the current order taking session. It will be understood that changes or alteration of other store or server information may be synchronized and communicated in the manner described herein. Alternatively, the RPOS system 120 can track the changes made to the local information since the last upload or update of the store database. In other words, changes can be identified between time-stamped versions of the local information without a direct comparison to the server information.

At block 508, the tracked changes or differences between the versions of local information and/or the local information and the server information can be identified and categorized to determine if an updated is required. Exemplary local information could include store information such as a malfunctioning fryer which will impact the availability of fried food items such as French fries or chicken strips, or store menu information such as the addition of a new food item. Thus, these changes in local information could be the result of planning by a store manager or regional director, etc., or could be the result of some uncontrollable or outside event, i.e., a power outage or delivery mistake. If an order taking session has been initiated between a customer and the agent 102, the necessary updates can be provided at the outset of the session to ensure that the agent has the most reliable information and can thereby serve the customer better. Alternatively, if an order taking session has been initiated and the updates are deemed to large or time consuming to communicate to the agent 102, the order distributor 106 can redirect the session to another agent with more current information. In yet another alternative, if an order taking session has not been initiated, the changed or modified local information can be uploaded via the remote order system interface 110 and the order distributor 106 for storage in the store database 122. It will be understood that these updating and synchronization strategies are intended to be illustrative only of the capabilities of the system 100, and are not intended to be limiting in any manner.

At block 510, assuming that an order taking session has been initiated, the identified changes or updates within the local information can be organized and/or formatted into a desirable form for communication to the remote order taking terminal 108. For example, changes in the business rules, menu items and options, etc. can be identified, organized into an appropriate format such as, for example, XML, HTML, .TXT file formats, for communication as dynamic data to the remote order taking terminal 108.

At block 512, the changes can, simultaneously or in a batch format, be communicated to the store database 122 via the order distributor 106. It will be understood, that the size and complexity of these update filed can be varied and adapted to be compensated for increases and decreases in the communications bandwidth between the interface 110 and terminal 108.

At block 514, the identified, changed local information, including the retail location-specific or remote commodity information, can be provided or communicated to the remote order taking terminal 108 and the agent 102 as a dynamic data communication. As previously discussed, this information exchange/update can occur before and/or as communication is initiated between the agent 102 and the customer who initiated the order at the store 146. The updated or changed local commodity information can be integrated and/or assimilated into the GUI 400 to display the latest menu information related to the store 146. For example, the provided changed menu information could include a new menu item such as, for example, a new wrap sandwich. If the wrap sandwich is part of the standard menu configuration displayed in the menu section 412, this item could be highlighted, the pricing updated, the graphical icon changed, or any other characteristic could be altered. However, if the new menu item is a non-standard item, e.g., it is not normally offered by associated restaurants and therefore would not be part of the standard menu, the menu item information, icon, etc. could be placed in special tab 442. For example, the “Other” tab 442b may be designated within the GUI 400.

With this arrangement, the GUI 400 can be configured to display a baseline commodity listing or standardized menu that includes all of the items typically or normally offered and provided by the store 146 or a large group of stores 146. The information within the GUI 400, as previously discussed, will typically be arranged in a consistent manner to allow the agent 102 to become familiar with the items, options and selections associated with the menu. The agent's familiarization with the organization and layout of the commodity listing or menu will provide for a speedy order taking process by reducing agent's need to search and hunt for ordered items and or features. When the changed or updated commodity information related to a specific retail location is received by the terminal 108, the overall look and feel of the GUI 400 will be maintained while the information is integrated and the display is normalized. For example, if the store 146 is on the west coast (i.e., in the Pacific Time Zone, GMT offset: −8:00) and the agent 102 is in the Midwest (i.e., the Central Time Zone, GMT offset: −6:00) the time differences may give rise to a situation where it is lunch time in the agent's time zone but breakfast time in the store's time zone. In this instance, the lunch tab 442a would still be listed to ensure menu continuity, but the lunch tab 442a could be made inaccessible, i.e., grayed out, or all of the items within the tab could be individually grayed out and a clock graphic 446 could be appended thereto. In this way, the look and feel of the GUI 400 is maintained while the menu selections are normalized or configured based on the needs and requirements of the individual store 146.

Regardless of the changes or information provided to the terminal 108, the GUI 400 maintains a constant, or essentially constant, configuration that is consistent and familiar to the agent. The update information received from the store database 122 or as part of a dynamic data update from the store 146 can be integrated into the GUI 400, thereby allowing the store menu information presented to the agent 102 to be normalized and customized for each store 146 while simultaneously preventing confusion that could arise if the display were to be constantly changed or reconfigured by each dynamic data update.

D. Database Update and Synchronization

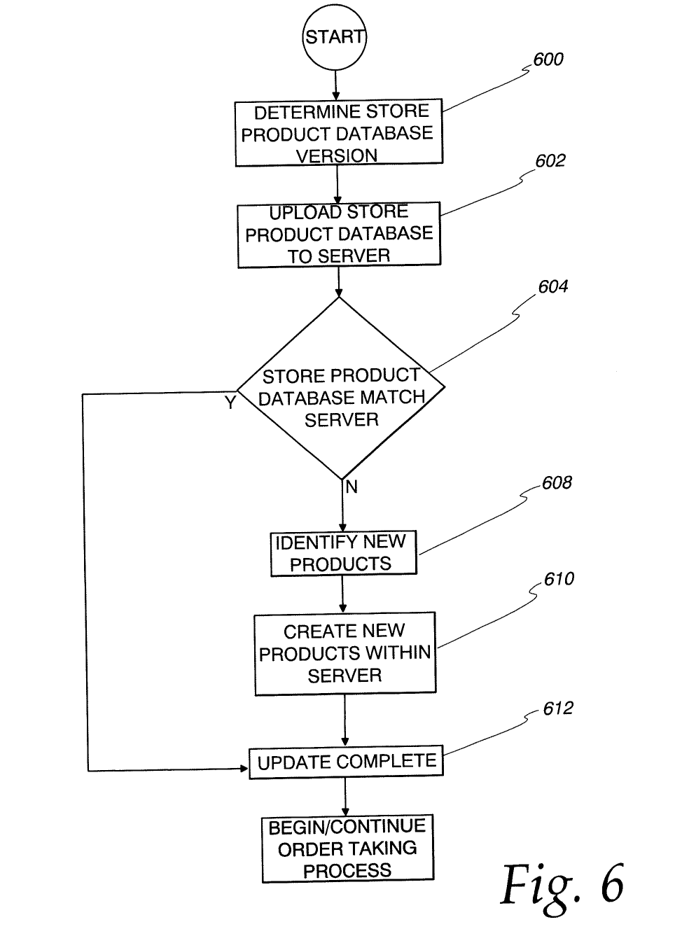

FIG. 6 illustrates an embodiment of an updating process that may be implemented and utilized in conjunction with the Interface Setup procedure discussed in Sections II-A. It will be understood that these updating steps can be implemented independent of the system start-up procedure or can be implemented in conjunction with the normal operations of the order processing system 100 to reflect changes or updates to the menu selections provided by the store 146.

At block 600, a system user (not shown), manager, programmer, etc. at the store 146 can compile and organize a particular commodity listing, a product list, product group or grouping, or a store menu. Non-standard menu items or commodities could include any number of food or non-food merchandise sold or provided by the store 146. The created commodity listing may, in turn, be assigned version information such as, for example, a time stamp or other identifier. The created commodity listing may be compared to the commodity listing stored on the order distributor 106 and/or store database 122.

At block 602, if the information or version of the commodity listing provided at the system interface 110 or store 146 is different than the information or commodity listing stored on the order distributor 106 and/or store database 122, the store product database or commodity listing can be uploaded to the store database 122.

At block 604, the individual menu items, product codes, business rules, contained within the uploaded commodity listing can be compared to the commodity listing stored or otherwise utilized on the order distributor 106 and/or store database 122. The comparison may include, for example, checks between the product codes and/or descriptions assigned to each item within the commodity listing. Alternatively, the comparison may include: pricing, promotions, quantity information and any other information that may be customized or altered at the store location 146. If the two commodity listings contain the same information, i.e., are the same version, an information upload may not be necessary and the operation may be discontinued or completed as indicated at block 610.

At block 606, the compared products or items within the uploaded commodity listing that match existing products within stored database can be mapped, synchronized or otherwise reconciled with the information contained on the order distributor 106 and/or store database 122. If the compared products or items within the uploaded commodity listing do not match products within stored database, the new items may be flagged or indicated for additional attention. These flagged items or products may be manually reconciled or inputted, or they may be subjected to one or more recognition routines configured to identify, associate and/or categorize products based on known parameters and values.

At block 608, the flagged values are integrated within the database 122. Thus, the provided or new products, promotions or business rules are generated and entered within the database 122. These new products, etc. may, in turn, be available to other stores or location for utilization in commodity listings associated with other store locations 146.

At block 610, the location and placement of button or icon information with the GUI 400 can be identified and associated with the new products and/or promotions. Upon completion of customization of the GUI 400, the update operation may be discontinued or completed. At this point, the information within the store database 122 and/or the order distributor 106 is synchronized and reconciled. The updated information may, in turn, be communicated to the order taking agent 102/terminal 108 via the static and/or dynamic data.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

Moreover, it should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A method for remote order entry, the method comprising:
storing a plurality of commodity listings, wherein each of the plurality of commodity listings is associated with a retail location;
communicating the plurality of commodity listings to an agent workstation;
displaying a baseline commodity listing in a first arrangement at the agent workstation;
defining a remote commodity listing at the retail location;
communicating the remote commodity listing to the agent workstation;
displaying, in response to an order request generated at the retail location, a normalized commodity listing as a part of the baseline commodity listing, wherein the normalized commodity listing is representative of at least one of the plurality of commodity listings and the remote commodity listing.

2. The method of claim 1, wherein displaying the baseline commodity listing includes displaying an overall listing of products and services offered by at the retail location.

3. The method of claim 1, wherein storing the plurality of commodity listings includes storing the plurality of commodity listings at a central storage location or at the agent workstation.

4. The method of claim 1, wherein defining the remote commodity listing includes defining the remote commodity listing at a restaurant point of sale terminal located at the retail location.

5. The method of claim 1, wherein displaying the baseline commodity listing includes displaying a group of graphical icons displayed in a first order.

6. The method of claim 5, wherein displaying the normalized commodity listing includes displaying a second group of graphical icons representative of the remote commodity listing in the first order.

7. The method of claim 1, wherein defining the remote commodity listing includes defining at least one variable commodity specific to the retail location.

8. The method of claim 7, wherein defining the at least one variable commodity includes defining a commodity that is provided in connection with baseline commodity listing.

9. A remote order entry system, the system comprising:
a communications network;
a first order entry workstation communicatively coupled to the communications network, the first order entry workstation configured to store a baseline commodity listing;
a second order entry workstation communicatively coupled to the first order entry workstation via the communication network, the second order entry workstation configured to communicate a remote commodity listing to the first order entry workstation; and
a graphical user interface executable on the first order entry workstation, the graphical user interface configured to display the baseline commodity listing in a first arrangement and the communicated remote commodity listing as a function of the first arrangement.

10. The system of claim 9, wherein baseline commodity listing represents an overall listing of products and services offered by a retailer.

11. The system of claim 9, wherein the first order entry workstation is an agent workstation located at a first location.

12. The system of claim 11, wherein second order entry workstation is a restaurant point of sale terminal located at a second location, wherein the second location is a different location than the first location.

13. The system of claim 11, wherein first location is selected from the group consisting of: a remote call center; an agent residence; or a retail location.

14. The system of claim 9, wherein the first arrangement includes a first group of graphical icons displayed in a first order.

15. The system of claim 9, wherein the remote commodity listing includes at least one variable commodity specific to the second order entry workstation.

16. The system of claim 15, wherein the at least one variable commodity is a commodity provided in connection with baseline commodity listing.

17. The system of claim 15, wherein the at least one variable commodity is a commodity communicated from the second order entry workstation to the first order entry workstation.

18. A remote order entry system, the system comprising:
a server configured to store and communicate a plurality of commodity listings, wherein each of the plurality of commodity listings is associated with a retail location;
a remote order entry terminal located at one of the retail locations, the remote order entry terminal configured to communicate a commodity update; and
an agent workstation located away from the remote order entry terminal, the agent workstation configured to display, in response to an order request received from the remote order entry terminal, a cumulative commodity listing representative of at least one of the plurality of commodity listings and the commodity update.

19. The system of claim 18 further comprising:
a speaker post communicatively coupled to the remote order entry terminal, wherein the speaker post is configured to a customer arrival indication.

20. The system of claim 18, wherein the server is configured to communicate the plurality of commodity listings to the agent workstation as part of a static data communication.

21. The system of claim 18, wherein the remote order entry terminal is configured to communicate the commodity update to the agent workstation as part of a dynamic data communication.

22. The system of claim 18, wherein the commodity update includes information selected from the group consisting of: a commodity listing, a business rule; a retail location status or an equipment status.

23. The system of claim 18 further comprising:
a graphical user interface configured for display by the agent workstation, wherein the graphical user interface is configured to generate a normalized display representative of the at least one of the plurality of commodity listings and the commodity update.

24. The system of claim 23, wherein the normalized display includes the cumulative commodity listing having a plurality of graphical icons arranged in a fixed order, and wherein the graphical user interface is configured to modify the plurality of graphical icons to display the commodity update.

25. The system of claim 24, wherein the graphical user interface is configured to display a status identifier in conjunction with at least one of the plurality of graphical icons.
